(19) United States
(12) Patent Application Publication
(10) Pub. No.: US 2026/0138586 A1
(43) Pub. Date: May 21, 2026

(54) VEHICLE BATTERY PRE-CHARGING APPARATUS AND METHOD FOR STAY MODE

(71) Applicants: Hyundai Motor Company, Seoul (KR); Kia Corporation, Seoul (KR)

(72) Inventors: Hye Joo LEE, Hwaseong-Si (KR); Sun Kyung KIM, Hwaseong-Si (KR)

(21) Appl. No.: 19/230,247

(22) Filed: Jun. 6, 2025

(30) Foreign Application Priority Data
Nov. 20, 2024 (KR) 10-2024-0166432

(51) Int. Cl. B60W 20/13; B60W 10/06; B60W 10/26; B60W 20/12; B60W 40/09; B60W 50/14; G06F 3/14; H02J 7/00

(52) U.S. Cl. CPC B60W 20/13; B60W 10/26; B60W 20/12; B60W 40/09; B60W 50/14; H02J 7/90; B60W 10/06; B60W 2050/146; B60W 2510/244; B60W 2520/04; B60W 2520/10; B60W 2530/209; B60W 2540/30; B60W 2556/45; B60W 2710/065; B60W 2710/244; B60W 2756/10; G06F 3/14

(57) ABSTRACT

An apparatus for a vehicle may comprise a processor and a memory storing at least one instruction that, when executed by the processor communicating with the memory, is configured to cause the apparatus to send, using an infotainment device of the apparatus, vehicle information of the vehicle to a server, receive, using the infotainment device, server analysis information of the vehicle information from the server, determine, based on the server analysis information of the vehicle information and a current state of the vehicle, a pre-charging plan for a stay mode of the vehicle, generate, based on the pre-charging plan, a signal requesting pre-charging a battery of the vehicle, and control, based on the signal and the pre-charging plan, the pre-charging the battery of the vehicle.

### CROSS-REFERENCE TO RELATED APPLICATION(S)

This application claims the benefit of priority to Korean Patent Application No. 10-2024-0166432 filed on Nov. 20, 2024 in the Korean Intellectual Property Office, the disclosure of which is incorporated herein by reference in its entirety.

### FIELD

The present disclosure relates to a vehicle battery pre-charging apparatus and method for a stay mode, which may be applied to a hybrid electric vehicle.

### BACKGROUND

The matters described in this Background section are only for enhancement of understanding of the background of the disclosure, and should not be taken as acknowledgment that they correspond to prior art already known to those skilled in the art.

A hybrid electric vehicle (HEV) may include a stay mode providing a vehicle convenience function and supplying power when a state of charge (SOC) is a certain level in an engine-off state.

The stay mode may be an operation mode of a vehicle allowing the use of convenience functions such as air conditioning, audio, and seat functions using a HEV high-voltage battery (e.g., 400 V or more) without starting an engine after charging to an SOC of 90% in a parking situation, as compared to general SOC management while travelling, and may aim to enable approximately 30 to 90 minutes of use without starting an engine, according to power usage.

A passenger may turn the stay mode on or off using infotainment or specific buttons of the vehicle. For example, in a vehicle with a stay mode, a battery may need to be charged to a certain level or higher before a passenger can use the stay mode smoothly at a desired time.

However, a vehicle with a stay mode may not include a charging control function or control logic for the stay mode, such that the vehicle may not be able to perform proper charging control for supporting the stay mode.

### SUMMARY

An example of the present disclosure provides a vehicle battery pre-charging apparatus and method for a stay mode, the apparatus and method capable of determining a possibility of using a stay mode based on server analysis information, determining a pre-charging plan for a battery to secure a state of charge (SOC) of the battery required in the stay mode in advance, before the stay mode is used, in consideration of the server analysis information and current state information of a vehicle to perform optimal and efficient pre-charging.

However, the examples of the present disclosure are not limited to those set forth herein, and other examples set forth herein will be more easily understood by those skilled in the art from the description below.

According to the present disclosure, an apparatus for a vehicle, the apparatus may comprise, a processor, and a memory storing at least one instruction that, when executed by the processor communicating with the memory, is configured to cause the apparatus to, send, using an infotainment device of the apparatus, vehicle information of the vehicle to a server, receive, using the infotainment device, server analysis information of the vehicle information from the server, determine, based on the server analysis information of the vehicle information and a current state of the vehicle, a pre-charging plan for a stay mode of the vehicle, generate, based on the pre-charging plan, a signal requesting pre-charging a battery of the vehicle, and control, based on the signal and the pre-charging plan, the pre-charging the battery of the vehicle.

The apparatus, wherein the server analysis information comprises at least one of: analysis information on a possibility of using the stay mode, analysis information on a driving habit of a driver of the vehicle, wherein the stay mode corresponds to a state in which the vehicle remains stationary with at least one onboard device consuming power from the battery of the vehicle, analysis information on a required period of time to a destination and energy characteristics associated with a travel route, based on the vehicle information, wherein the vehicle information comprises vehicle driving information, a profile of the driver, vehicle travel information, and vehicle fuel information.

The apparatus, wherein the server analysis information comprises at least one of: (i) analysis information regarding whether the vehicle is stationary and occupied for a reference period of time or longer, (ii) analysis information regarding whether a destination is set to a place in which a number of drivers, using the stay mode, is greater than or equal to a reference number of drivers, or (iii) analysis information regarding whether the destination is a preset place having a stay mode usability.

The apparatus, wherein the at least one instruction, when executed by the processor communicating with the memory, is configured to cause the apparatus to display, using the infotainment device, a pop-up window for a stay mode operation recommendation on a screen based on the server analysis information indicating at least one of, whether the vehicle is stationary and occupied for a reference period of time or longer, whether a destination being set to a place in which a number of drivers, using the stay mode, is greater than or equal to a reference number of drivers, or whether the destination being a preset place having a stay mode usability level exceeding a threshold level.

The apparatus, wherein the at least one instruction, when executed by the processor communicating with the memory, is configured to cause the apparatus to, obtain the vehicle information may comprise vehicle driving information, a profile of a driver of the vehicle, and navigation information, wherein the navigation information may comprise vehicle travel information, perform entry into and exit from the stay mode of the vehicle, determine, before performing the stay mode, the pre-charging plan for the stay mode based on a possibility of using the stay mode.

The apparatus, wherein the at least one instruction, when executed by the processor communicating with the memory, is configured to cause the apparatus to, determine a pre-charging necessity based on the possibility of using the stay mode, determine, based on the pre-charging necessity, the current state of the vehicle, determine, based on the current state of the vehicle, the pre-charging plan, wherein the pre-charging plan may comprise a charging start point in time and a charging method, and wherein the charging start point in time is determined based on a remaining period of time until arrival of the vehicle to a destination, and request, based on the pre-charging plan, pre-charging the battery of the vehicle.

The apparatus, wherein the at least one instruction, when executed by the processor communicating with the memory, is configured to cause the apparatus to, determine the current state of the vehicle based on a travel speed to the destination and the remaining period of time, and determine the pre-charging plan, wherein the charging start point in time corresponds to a departure time at which the vehicle begins traveling toward the destination.

The apparatus, wherein the at least one instruction, when executed by the processor communicating with the memory, is configured to cause the apparatus to, determine the current state of the vehicle based on the remaining period of time and a difference between a target state of charge (SOC) set for the battery and a current SOC of the battery, and determine the pre-charging plan, wherein the charging start point in time is set at a point in time corresponding to a predetermined portion of the remaining period of time until arrival.

The apparatus, wherein the at least one instruction, when executed by the processor communicating with the memory, is configured to cause the apparatus to, determine the current state of the vehicle based on a capacity of the battery and the remaining period of time, and determine the pre-charging plan, wherein the charging start point in time is set at a point in time corresponding to a predetermined portion of the remaining period of time until arrival.

The apparatus, wherein the at least one instruction, when executed by the processor communicating with the memory, is configured to cause the apparatus to, determine the current state of the vehicle based on a remaining amount of fuel estimated at an arrival point and the remaining period of time, and determine the pre-charging plan, wherein the charging start point in time corresponds to a departure time at which the vehicle begins traveling toward the destination.

The apparatus, wherein the at least one instruction, when executed by the processor communicating with the memory, is configured to cause the apparatus to, determine the current state of the vehicle based on route characteristics to the destination and the remaining period of time, wherein the route characteristics comprise at least one of a number of climbs or a number of descents, and determine the pre-charging plan, wherein the charging start point in time is set at a point in time corresponding to a predetermined portion of the remaining period of time until arrival.

The apparatus, wherein the at least one instruction, when executed by the processor communicating with the memory, is configured to cause the apparatus to, determine the current state of the vehicle based on a driving habit of a driver of the vehicle and the remaining period of time, wherein the driving habit may comprise at least one of a driving style or a stay mode preference, and determine the pre-charging plan, wherein the charging start point in time is set at a point in time corresponding to a predetermined portion of the remaining period of time until arrival.

According to the present disclosure, a method performed by an apparatus for a vehicle, the method may comprise, sending vehicle information of the vehicle to a server, receiving server analysis information of the vehicle information from the server, determining whether to perform pre-charging a battery of the vehicle based on the server analysis information of the vehicle information, based on a determination to perform the pre-charging, determining a pre-charging plan for a stay mode of the vehicle based on a current state of the vehicle, generating, based on the pre-charging plan, a signal requesting pre-charging the battery of the vehicle, and controlling, based on the signal and the pre-charging plan, the pre-charging the battery of the vehicle.

The method, wherein the server analysis information comprises at least one of: analysis information on a possibility of using the stay mode, analysis information on a driving habit of a driver of the vehicle, and analysis information on a required period of time to a destination and energy characteristics associated with a travel route, based on the vehicle information, wherein the vehicle information comprises vehicle driving information, a profile of the driver, vehicle travel, and vehicle fuel information.

The method, wherein the pre-charging plan for the stay mode of the vehicle is based on at least one of, whether the vehicle is stationary and occupied for a reference period of time or longer, whether a destination is set to a place in which a number of drivers, using the stay mode, is greater than or equal to a reference number of drivers, or whether the destination is a preset place having a stay mode usability level exceeding a threshold level.

The method may further comprise, determining a stay mode recommendation necessity based on a possibility of using the stay mode, wherein the possibility of using the stay mode is based on at least one of, whether the vehicle is stationary and occupied for a reference period of time or longer, whether a destination is set to a place in which a number of drivers, using the stay mode, is greater than or equal to a reference number of drivers, or whether the destination is a preset place having a stay mode usability level exceeding a threshold level, and displaying, based on the determining the stay mode recommendation necessity, a pop-up window for a stay mode recommendation on a screen.

The method may further comprise, determining the current state of the vehicle based on a possibility of using the stay mode and the server analysis information of the vehicle information, and determining, based on the current state of the vehicle, a pre-charging plan, wherein the pre-charging plan may comprise a charging start point in time and a charging method, and wherein the charging start point in time corresponds to a departure time at which the vehicle begins traveling toward a destination.

The method, wherein the determining the current state of the vehicle is based on at least one of, a travel speed to the destination and a remaining period of time until arrival of the vehicle to the destination, a difference between a target state of charge (SOC) set for the battery and a current SOC of the battery and the remaining period of time, a capacity of the battery and the remaining period of time, a remaining amount of fuel estimated at an arrival point and the remaining period of time, route characteristics to the destination and the remaining period of time, or a driving habit of a driver of the vehicle and the remaining period of time, wherein the driving habit may comprise at least one of a driving style or a stay mode preference.

According to the present disclosure, an apparatus for a vehicle, the apparatus may comprise, a processor, and a memory storing at least one instruction that, when executed by the processor communicating with the memory, is configured to cause the apparatus to, determine whether to recommend a stay mode of the vehicle based on analysis data of vehicle information from a server, wherein the stay mode corresponds to a state in which the vehicle remains stationary with at least one onboard device consuming power from a battery of the vehicle, determine, based on a current state of the vehicle and a determination to recommend the stay mode, a pre-charging plan for pre-charging the battery of the vehicle, and control, based on the pre-charging plan, pre-charging the battery before operating the vehicle in the stay mode.

The apparatus, wherein whether to recommend the stay mode is based on at least one of, whether the vehicle remains stationary with an occupant for at least a reference period of time, and whether a destination of the vehicle corresponds to a location having a frequency of stay mode usage exceeding a reference threshold.

However, the various and beneficial advantages and effects of the present disclosure are not restricted to those set forth herein, and will be more easily understood in the process of describing specific examples.

### BRIEF DESCRIPTION OF DRAWINGS

The above and other examples, features, and advantages of the present disclosure will be more clearly understood from the following detailed description, taken in conjunction with the accompanying drawings, in which:

FIG. 1 shows an example of a configuration of a vehicle battery pre-charging apparatus for a stay mode according to an example of the present disclosure;

FIG. 2 shows an example of a configuration of a vehicle information server;

FIG. 3 shows an example of a configuration of an information analysis processor;

FIG. 4 shows an example of a stay mode pop-up window of an infotainment device;

FIG. 5 shows an example of a configuration of an infotainment device;

FIG. 6 shows an example of a configuration of a stay mode processing unit;

FIG. 7 shows an example of a pre-charging plan 1 of an infotainment device;

FIG. 8 shows an example of a pre-charging plan 2 of an infotainment device;

FIG. 9 shows an example of a pre-charging plan 3 of an infotainment device;

FIG. 10 shows an example of a pre-charging plan 4 of an infotainment device;

FIG. 11 shows an example of a pre-charging plan 5 of an infotainment device;

FIG. 12A shows an example of a pre-charging plan 6-1 of the infotainment device, and FIG. 12B shows an example of a pre-charging plan 6-2 of an infotainment device;

FIG. 13 shows an example of a vehicle battery pre-charging method for a stay mode according to an example of the present disclosure;

FIG. 14 shows an example of a pre-charging operation;

FIG. 15 shows an example of a server analysis information generation operation;

FIG. 16 shows an example of a detailed operation of a server analysis information generation operation;

FIG. 17 shows an example of a detailed operation of a pre-charging necessity determination operation;

FIG. 18 shows an example of a detailed operation of a pre-charging plan operation;

FIG. 19 shows an example of a detailed operation of a pre-charging plan determination operation; and

FIG. 20 shows an example of a computing device 1000 capable of entirely or partially implementing a vehicle battery pre-charging apparatus and method for a stay mode according to an example of the present disclosure.

### DETAILED DESCRIPTION

Hereinafter, specific examples of the present disclosure will be described with reference to the accompanying drawings. The following detailed description is provided to aid in a comprehensive understanding of a method, an apparatus, and/or a system described in the present specification. However, the detailed description is for illustrative purposes only, and the present disclosure is not limited thereto.

In describing the examples of the present disclosure, when it is determined that a detailed description of a known technology related to the present disclosure may unnecessarily obscure the gist of the present disclosure, the detailed description thereof will be omitted. In addition, terms to be described below are terms defined in consideration of functions in the present disclosure, which may vary depending on intention or custom of a user or operator. Therefore, the definition of these terms should be made based on the contents throughout the present specification. The terminology used herein is for the purpose of describing particular examples only and is not to be limiting of the examples. As used herein, the singular forms “a,” “an,” and “the” are intended to include the plural forms as well, unless the context clearly indicates otherwise. As used herein, the term “and/or” includes any one and any combination of any two or more of the associated listed items. It will be further understood that the terms “comprises” and/or “comprising,” when used in this specification, specify the presence of stated features, integers, steps, operations, elements, components or a combination thereof, but do not preclude the presence or addition of one or more other features, integers, steps, operations, elements, components, and/or groups thereof.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

Hereinafter, preferred examples of the present disclosure will be described in more detail with reference to the accompanying drawings.

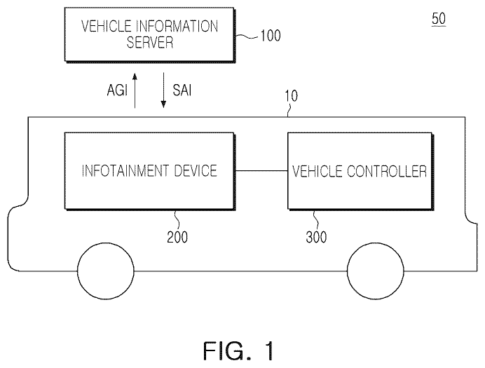

FIG. 1 shows an example of a configuration of a vehicle battery pre-charging apparatus for a stay mode according to an example of the present disclosure.

Referring to FIG. 1, a vehicle battery pre-charging apparatus 50 for a stay mode according to an example of the present disclosure may include an infotainment device 200 mounted on a vehicle 10, and a vehicle controller 300. In the present disclosure, the vehicle may be a hybrid electric vehicle, or a vehicle requiring charging before the stay mode is activated, and the vehicle is not limited to the hybrid electric vehicle. (e.g., a plug-in hybrid electric vehicle (PHEV), a battery electric vehicle (BEV), or a fuel cell electric vehicle (FCEV), etc.)

The infotainment device 200 may upload vehicle general information VGI including various types of pieces of information on the vehicle to a vehicle information server 100, and download server analysis information SAI from the vehicle information server 100. For example, the infotainment device 200 may comprise a vehicle head circuit that integrates navigation, media playback, and system control features, a touchscreen interface that provides access to vehicle settings, maps, and stay mode options, a smart display system with voice recognition and driver profiling, an embedded Android Automotive or Apple CarPlay system that communicates with cloud services and external devices, or a dashboard- or center-console-mounted interface supporting stay mode recommendations, pre-charging plan management, and communication with vehicle controllers and external servers, etc. If there is a possibility of using the stay mode based on the server analysis information SAI and the vehicle general information VGI, the infotainment device 200 may determine a pre-charging plan for the stay mode according to a current state of the vehicle, and may request pre-charging according to the pre-charging plan from the vehicle controller 300.

For example, the infotainment device 200, an integrated system of information indicating necessary information such as driving and guidance, and entertainment indicating various entertainments and human-friendly functions, may be a device in which vehicle navigation, audio, video, and the Internet are combined (e.g., navigation map display, music streaming, voice assistant support, or remote diagnostics, etc.), which will be described with reference to FIGS. 4 to 6, and 7 to 12.

In addition, the vehicle controller 300 may control pre-charging for a battery of the vehicle according to the pre-charging plan received from the infotainment device 200 in response to a request from the infotainment device 200.

For example, the vehicle controller 300 may be an electronic control unit (ECU) or a vehicle control unit (VCU) of the vehicle 10, but the present disclosure is not limited thereto (e.g., the controller may alternatively be implemented as a powertrain control circuit (PCC) or body control circuit (BCC), etc.).

In addition, referring to FIG. 1, the vehicle battery pre-charging apparatus 50 may include a vehicle information server 100.

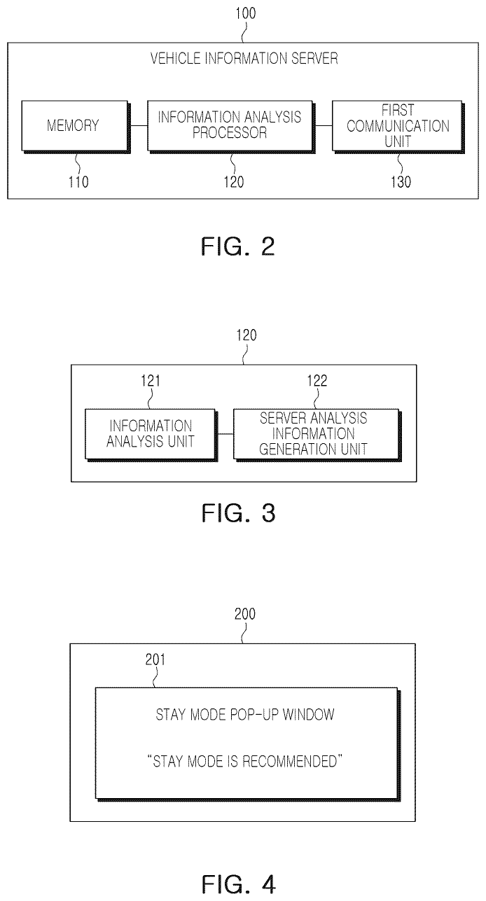

With respect to each vehicle, the vehicle information server 100 may (i) analyze a possibility of using a stay mode, (ii) analyze a driving habit, and (iii) analyze a required period of time and energy characteristics (e.g., expected energy usage based on a route's condition such as climbs, descents, stop-and-go traffic, battery depletion patterns over time or distance, fuel usage patterns, energy recover opportunities, for example, through regenerative braking, power demands from auxiliary systems such as HVAC, infotainment, which may affect energy availability for stay mode, etc.) according to a route during travel, based on the vehicle general information VGI, to transmit server analysis information SAI on each vehicle to the infotainment device 200 of each vehicle, which will be described with reference to FIGS. 2 and 3 (e.g., the server may analyze repeated visits to parking lots, frequent idling at pickup zones, preferred use of air conditioning during stops, or selection of destinations like campsites or supermarkets, etc.).

Wherein the server analysis information SAI includes at least one of: analysis information on a possibility of using the stay mode, analysis information on a driving habit of a driver of the vehicle, wherein the stay mode corresponds to a state in which the vehicle remains stationary with at least one onboard device consuming power from the battery of the vehicle, analysis information on a required period of time to a destination and energy characteristics.

In the drawings of the present disclosure, unnecessary repeated descriptions of components having the same reference numeral and the same function may be omitted, and differences between the drawings may be described where appropriate for clarity.

FIG. 2 shows an example of a configuration of a vehicle information server.

Referring to FIG. 2, the vehicle information server 100 may include a server memory 110, an information analysis processor 120, and a first communication unit 130.

The server memory 110 may store the vehicle general information VGI. For example, the vehicle general information VGI may include various types of pieces of vehicle information (e.g., data elements or categories of information, etc.) received for each vehicle (e.g., trip history, energy consumption trends, destination patterns, or in-vehicle sensor data, etc.).

For example, the vehicle general information VGI may include destination characteristics (a camping site, a supermarket, a school, a work place, a recommended place, or a user-defined point of interest, etc.), vehicle driving information, a driver profile, navigation information (including vehicle travel information such as a travel route to a destination, a travel period of time, or a remaining period of time, etc.), and vehicle current state information (the number of passengers, a type of fuel, a required battery amount, or a current state of charge (SOC) level, etc.).

The information analysis processor 120 may analyze a possibility of using a stay mode for each vehicle, based on the vehicle general information VGI, and may generate the server analysis information SAI including an analysis result (e.g., a stay mode usage likelihood score, preferred destinations for stay mode, or time-based usage predictions, etc.).

In addition, the first communication unit 130 may receive the vehicle general information VGI from the infotainment device 200 of each vehicle, and may transmit the server analysis information SAI to the infotainment device 200 of a corresponding vehicle (e.g., via a mobile network, Wi-Fi hotspot, or vehicle-to-cloud communication, etc.).

A vehicle including the infotainment device 200 may be, for example, a connectivity car that may be connected to various devices (e.g., smartphones, external vehicles, transportation infrastructure, smart homes, or cloud-based services, etc.), and accordingly, real-time two-way communication with various connection targets may be performed while moving through a network connection based on the Internet and cloud services.

In the present disclosure, each of the server memory 110, the information analysis processor 120, and the first communication unit 130 may be implemented as an individual processor, or may be implemented as a single integrated processor, but the present disclosure is not limited thereto (e.g., implemented on a centralized server, a distributed edge computing platform, or a virtualized cloud instance, etc.).

FIG. 3 shows an example of a configuration of an information analysis processor.

The information analysis processor 120 may include an information analysis unit 121 and a server analysis information generation unit 122.

With respect to each vehicle, the information analysis unit 121 may analyze, based on the vehicle general information VGI, (i) whether each vehicle that is in an idling state (e.g., a vehicle is stationary or not moving, etc.) is in a riding state (e.g., a vehicle is occupied by a driver and/or passengers, etc.) for a reference period of time or longer, (ii) whether a set destination (e.g., location that the current driver has entered into the navigation system or is currently travelling toward) is a place in which the number of general drivers, using the stay mode, is greater than or equal to a reference number of drivers (e.g., how frequently the stay mode is used at a particular destination by the general driver population and comparing the frequency to a preset threshold, for example, 5 or more drivers per day typically active stay mode at a particular destination, etc.), and/or (iii) whether the set destination is a preset place having high stay mode usability (e.g., a rest area, event venue, large retail center, or popular tourist spot, etc.).

Wherein the server analysis information SAI includes at least one of: (i) analysis information regarding whether the vehicle is stationary and occupied for a reference period of time or longer, (ii) analysis information regarding whether a destination is set to a place in which a number of drivers, using the stay mode, is greater than or equal to a reference number of drivers, or (iii) analysis information regarding whether the destination is a preset place having a stay mode usability.

In addition, the server analysis information generation unit 122 may generate the server analysis information SAI including an analysis result (e.g., prediction flags, charging trigger recommendations, or suggested stay mode activation times, etc.).

FIG. 4 shows an example of a stay mode pop-up window of an infotainment device.

Referring to FIG. 4, the infotainment device 200 may display a pop-up window 201 for stay mode recommendation, if each vehicle, which is in an idling state, is in a riding state, for example, an idling place (e.g., parked with passengers onboard, waiting at a school pickup zone, or stopped in a parking lot, etc.) for a reference period of time or longer, if a set destination is a place (e.g., a place other than a campsite in which a stay mode is frequently used in advance) in which the number of general drivers, using the stay mode, is greater than or equal to a reference number of drivers (e.g., five or more users per day, ten or more weekly users, or any statistically significant usage threshold, etc.), and/or if the set destination is a preset place (e.g., a campsite, a rest area, a charging station, or a recreational area, etc.) having high stay mode usability.

In the present disclosure, the examples are only examples for description and understanding, and thus are not limited to the examples, and may be interpreted as a stay mode recommendation target if a place is a place in which a stay mode is highly likely to be used (e.g., based on historical usage data, location type, driver habits, or time of day, etc.).

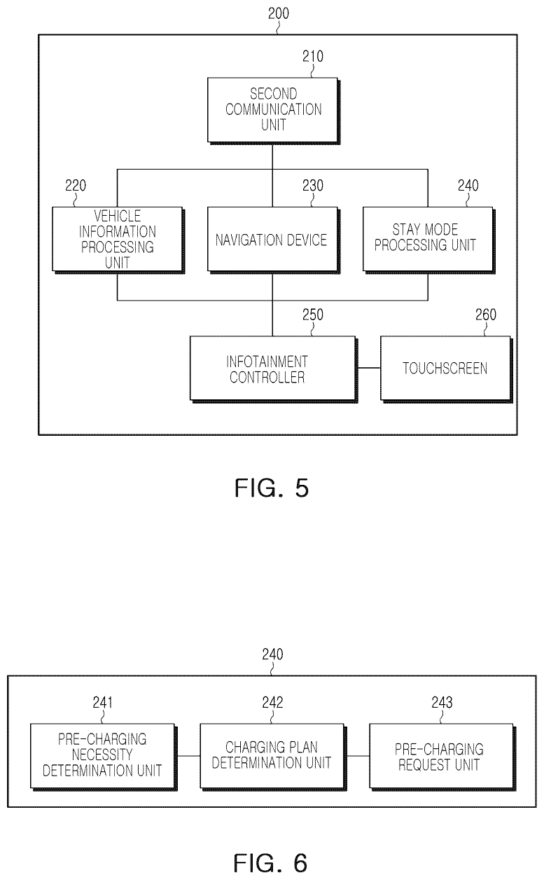

For example, the pop-up window 201 for stay mode operation recommendation may display a stay mode recommendation phrase on a touchscreen 260 (see FIG. 5) of the infotainment device 200. For example, the stay mode recommendation phrase may be “Stay Mode is recommended,” “Do you want to turn on Stay Mode?” “Enable Stay Mode for comfort?” or “Tap to enter Stay Mode,” etc.

FIG. 5 shows an example of a configuration of an infotainment device.

Referring to FIG. 5, the infotainment device 200 may include a second communication unit 210, a vehicle information processing unit 220, a navigation device 230, a stay mode processing unit 240, an infotainment controller 250, and a touchscreen 260 (e.g., housed in a central console, dashboard, or rear-seat entertainment system, etc.).

The second communication unit 210 may upload the vehicle general information VGI to the vehicle information server 100, and may download the server analysis information SAI from the vehicle information server 100 (e.g., using LTE, 5G, DSRC, or other telematics protocols, etc.).

The vehicle information processing unit 220 may acquire the vehicle general information VGI including the vehicle driving information, the driver profile, and the navigation information, and may transmit the acquired vehicle information to the second communication unit 210. For example, the vehicle driving information may include whether the vehicle idles, an idling period of time, an idling position, gear determination information, or the like (e.g., engine status, gear position, or accelerator pedal input, etc.). The driver profile may include sudden acceleration and information on sudden acceleration, information on a degree of use of a stay mode, information on use of idling, or the like capable of determining a driving habit of a driver (e.g., frequent stops, long idle durations, or repeated visits to known stay mode locations, etc.).

The navigation device 230 may provide the navigation information including vehicle travel information to the vehicle information processing unit 220. For example, the navigation information may include information such as vehicle location information, a route of the vehicle based on arrival at a destination, energy prediction information, and a remaining travel distance and period of time to the destination (e.g., 25 km remaining and 30 minutes estimated arrival, etc.).

The stay mode processing unit 240 may perform entry into and exit from the stay mode according to selection of the driver. Before the stay mode is performed, if there is a possibility of using the stay mode based on the server analysis information SAI and the vehicle general information VGI, the stay mode processing unit 240 may determine a pre-charging plan for the stay mode according to a current state of the vehicle, and may request pre-charging from the infotainment controller 250, using the pre-charging plan (e.g., SOC, fuel level, terrain type, driving habit, etc.).

The infotainment controller 250 may communicate with the vehicle controller 300 to receive the vehicle general information VGI, transmit the vehicle general information VGI to the vehicle information processing unit 220, and transmit a pre-charging request from the stay mode processing unit 220 to the vehicle controller 300 (e.g., via CAN bus or Ethernet automotive network, etc.).

In addition, the touchscreen 260 may output a stay mode recommendation pop-up window 201, a driving information screen including vehicle driving information, a navigation map for road guidance, and navigation-related information through the screen, and may output a touch button for an input for selection to receive the input and perform predetermined processing (e.g., confirming Stay Mode activation, selecting a destination, or setting preferences, etc.).

In the present disclosure, each of the second communication unit 210, the vehicle information processing unit 220, the navigation device 230, the stay mode processing unit 240, the infotainment controller 250, and the touchscreen 260 may be implemented as an individual processor, or may be implemented as a single integrated processor, but the present disclosure is not limited thereto (e.g., a single-chip system, multiple ECUs, or a domain controller architecture, etc.).

In addition, the second communication unit 210, the vehicle information processing unit 220, the navigation device 230, the stay mode processing unit 240, the infotainment controller 250, and the touchscreen 260 may be implemented as hardware element(s), software element(s), or a combination thereof in at least one integrated circuit (IC) embedded in the infotainment device 200, but the present disclosure is not limited thereto (e.g., implemented using embedded software, application-specific integrated circuits (ASICs), or field-programmable gate arrays (FPGAs), etc.).

In the present disclosure, the first communication unit 130 and the second communication unit 210 may communicate with each other using a communication network according to the related art, such that the vehicle information server 100 and the infotainment device 200 may communicate with each other. For example, the communication network according to the related art may use at least one of a GNSS satellite communication/a global positioning system (GPS) satellite communication, a base station network communication, an Internet communication, a telecommunication service, and satellite delivery communications (e.g., 4G LTE, NB-IoT, or V2X infrastructure, etc.). The present disclosure is not limited to the communication examples.

FIG. 6 shows an example of a configuration of a stay mode processing unit.

Referring to FIG. 6, the stay mode processing unit 240 may include a pre-charging necessity determination unit 241, a pre-charging plan determination unit 242, and a pre-charging request unit 243.

The pre-charging necessity determination unit 241 may determine whether there is pre-charging necessity according to a possibility of using a stay mode, based on the server analysis information SAI and the vehicle general information VGI (e.g., destination type, idling behavior, travel duration, or past stay mode usage, etc.).

If there is a determined pre-charging necessity, the pre-charging plan determination unit 242 may determine a current state of the vehicle, based on the server analysis information SAI and the vehicle general information VGI (e.g., vehicle travel information, fuel level information, driving speed information, or battery SOC information, etc.), and may determine a pre-charging plan (e.g., initiating charging at a point in time when a remaining period of time until arrival is 100%, 80%, or 50%, etc.) in relation to a charging start point in time and a charging method, based on a determination result.

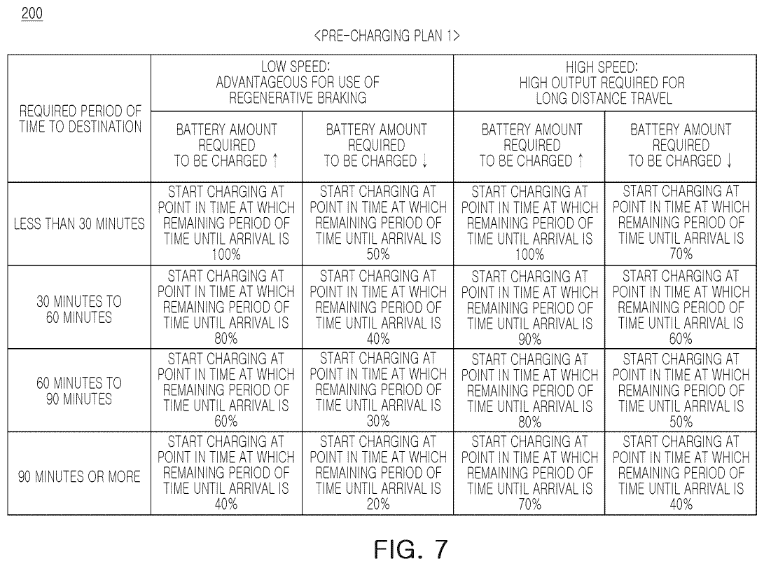

For example, in the present disclosure, a section in which charging is to be focused on may be controlled based on a remaining period of time (e.g., remaining driving time segmented into early, middle, or final travel phases, etc.). For example, a distance instead of the remaining period of time may be used, and a time to focus on charging (start charging) may be determined by a pre-charging plan such that pre-charging is controlled with a focus on engine output while maintaining a battery capacity according to an arrival point in time. For example, a pre-charging period of time may be adjusted according to whether a driver is a driver enjoying a stay mode (e.g., a driver who frequently idles with HVAC on, routinely uses in-vehicle systems while parked, or has a historical preference for quiet, engine-off conditions, etc.). The pre-charging plan will be described with reference to FIGS. 7 to 12.

In addition, the pre-charging request unit 243 may request pre-charging according to the pre-charging plan from the infotainment controller 250 (e.g., via a control signal indicating charging start time, target SOC, and charging intensity, etc.).

FIG. 7 shows an example of a pre-charging plan 1 of an infotainment device.

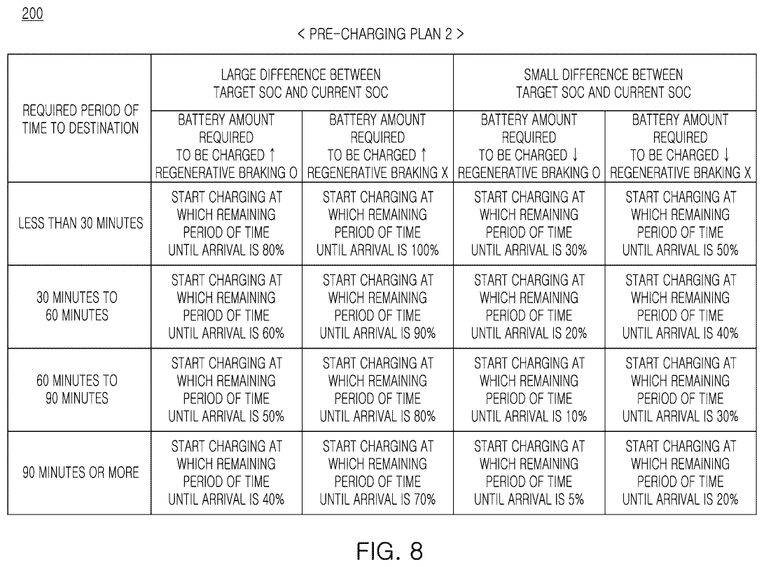

Referring to FIG. 7, the infotainment device 200 may determine a current state of the vehicle according to a travel speed to a set destination (e.g., highway driving, urban driving, stop-and-go traffic, or rural cruising, etc.), for example, a high speed if the travel speed is equal to or higher than a reference speed or a low speed if the travel speed is lower than the reference speed, and a remaining period of time, e.g., a time section in which a remaining period of time until arrival at the destination is subdivided into ranges such as 0-30%, 30-60%, or 60-100%, etc., based on the server analysis information SAI and the vehicle general information VGI (e.g., vehicle travel information, fuel level information, or route history information, etc.), and may determine a pre-charging plan 1 (e.g., charging is started at a point in time at which the remaining period of time until arrival is 100%, 70%, or 40%, etc.), according to a determination result. In FIG. 7, an upward arrow may mean that a battery amount required to be charged for stay mode use at the destination is relatively high when it is determined based on a current battery amount of the vehicle (e.g., when the remaining SOC is low, energy demand is high, or the route involves uphill driving, etc.), and a downward arrow may mean that the battery amount required to be charged for stay mode use at the destination is relatively low when it is determined based on the current battery amount of the vehicle (e.g., when SOC is sufficient, stay duration is short, or recent regenerative braking was effective, etc.). The upward arrow and the downward arrow may also be applied to FIGS. 8 to 12B (e.g., to visually indicate pre-charging intensity, urgency, or SOC gap in other scenarios, etc.).

Referring to the pre-charging plan 1 illustrated in FIG. 7, whether the current travel speed is a low speed or a high speed may be determined (e.g., based on whether the vehicle is moving below or above a threshold speed such as 30 km/h or 80 km/h, etc.). With respect to each of a case in which the current travel speed is a low speed and a case in which the current travel speed is a high speed, whether a battery amount required to be charged is greater or less than a preset reference amount may be determined (e.g., based on thresholds such as 20% SOC, projected energy demand, or estimated HVAC usage during stay mode, etc.). With respect to the above-described cases, the pre-charging plan 1 may be determined according to the required period of time (or the remaining period of time) to the destination (e.g., based on thresholds such as less than 30 minutes, between 30-60 minutes, or more than 90 minutes, etc.).

For example, if the current travel speed of the vehicle is a low speed (e.g., in urban traffic, residential zones, or during congestion, etc.), the battery amount required to be charged is greater than the reference amount (e.g., due to low SOC, high anticipated HVAC usage, or planned long stay mode duration, etc.), and the period of time required (or the remaining period of time) to the destination is less than 30 minutes (e.g., for short commutes, errands, or nearby event stops, etc.), a detailed pre-charging plan in which charging is started at a point in time at which the remaining period of time until arrival is 100% (that is, at the same time as departure) may be determined in the pre-charging plan 1. In addition, a case in which the required period of time to the destination is less than 30 minutes (e.g., a short-distance trip or local stop, etc.) and the battery amount required to be charged is high based on the current battery amount of the vehicle may be relatively insufficient, as compared to a case in which the battery amount required to be charged is low (e.g., due to a nearly full battery, short stay mode usage, or recent regenerative braking, etc., charging is instead started at a point in time at which the remaining period of time is 50% or later, etc.). Thus, the detailed pre-charging plan in which charging is started at a point in time at which the remaining period of time until arrival is 100% (that is, at the same time as departure) may be determined.

For another example, if the current travel speed of the vehicle is a high speed (e.g., during highway cruising, expressway travel, or sustained acceleration, etc.), the battery amount required to be charged is less than the reference amount (e.g., due to a high current SOC, low expected stay mode demand, or short stop duration, etc.), and the required period of time (or the remaining period of time) to the destination is 90 minutes or more (e.g., for long-distance travel or intercity driving, etc.), a detailed pre-charging plan in which charging is started at a point in time at which the remaining period of time until arrival is 40% may be determined in the pre-charging plan 1. In addition, a case in which the required period of time to the destination is 90 minutes or more and the battery amount required to be charged is low based on the current battery amount required to be charged may allow a later charging window, as compared to a case in which the battery amount required to be charged is high (e.g., charging is started at a point in time at which the remaining period of time until arrival is 70% or earlier, etc.). Thus, the detailed pre-charging plan in which charging is started at a point in time at which the remaining period of time until arrival is 40% may be determined.

The pre-charging plan 1 illustrated in FIG. 7 is only one example for description and understanding, and thus the present disclosure is not limited thereto (e.g., other plans may consider driver preference, real-time traffic, or terrain features such as uphill/downhill sections, etc.).

FIG. 8 shows an example of a pre-charging plan 2 of an infotainment device.

Referring to FIG. 8, the infotainment device 200 may determine a current state of the vehicle, according to a difference between a target state of charge (SOC) set for the battery of the vehicle and a current SOC (e.g., if the difference is greater than or equal to a reference value such as 20%,, or less than the reference value such as 10%, etc.) and a remaining period of time, (e.g., a time section in which a remaining period of time until arrival at a destination is subdivided into intervals such as 0 -30 minutes, 30-60 minutes, or over 90 minutes, etc.), based on the server analysis information SAI and the vehicle general information VGI (e.g., vehicle travel information, fuel status information, energy consumption patterns, or recent destination history, etc.)), and may determine a pre-charging plan 2 (e.g., charging is started at a point in time at which the remaining period of time until arrival is 80%, 50%, or 30%, etc.), according to a determination result. In FIG. 8, an upward arrow may mean that the difference between the target SOC and the current SOC has a value greater than the reference value, and a downward arrow may mean that the difference between the target SOC and the current SOC has a value less than the reference value.

Referring to the pre-charging plan 2 illustrated in FIG. 8, whether the difference between the target SOC and the current SOC has a value greater or less than the reference value may be determined (e.g., when the gap exceeds 20%, is below 10%, or falls within a critical range, etc.). With respect to each of a case in which the difference has a value greater than the reference value and a case in which the difference has a value less than the reference value, whether regenerative braking is used (O) or regenerative braking (X) is not used may be determined (e.g., based on vehicle deceleration history, road slope, or energy recovery settings, etc.). With respect to the above-described cases, the pre-charging plan 2 may be determined according to the required period of time (or the remaining period of time) to the destination (e.g., categorized into short trips under 30 minutes, medium trips between 30-60 minutes, or long trips over 90 minutes, etc.).

For example, if the difference between the target SOC and the current SOC has a value greater than the reference value, that is, the target SOC and the current SOC have a large difference therebetween, regenerative braking is used (O), and the required period of time (or the remaining period of time) to the destination is less than 30 minutes (e.g., for a short trip to a nearby location, such as a grocery store, charging station, or school, etc.), a detailed pre-charging plan in which charging is started at a point in time at which the remaining period of time until arrival is 80% may be determined in the pre-charging plan 2. In addition, a case in which the period of time required to the destination is less than 30 minutes and regenerative braking is performable may be relatively sufficient, as compared to a case in which the regenerative braking is not performable (e.g., due to flat terrain, constant-speed driving, or minimal deceleration, etc., charging is started earlier, at a point in time at which the remaining period of time is 100%—at the same time as departure, etc.). Thus, the detailed pre-charging plan in which charging is started at a point in time at which the remaining period of time until arrival is 80% may be determined.

For another example, if the difference between the target SOC and the current SOC has a value less than the reference value (e.g., indicating the battery is already near the desired charge level, such as within 5-10%, etc.), regenerative braking is not used (X) (e.g., due to flat road conditions, constant-speed cruising, or disabled energy recovery settings, etc.), and the required period of time (or the remaining period of time) to the destination is 90 minutes or more (e.g., during long-distance highway driving or extended intercity travel, etc.), a detailed pre-charging plan in which charging is started at a point in time at which the remaining period of time until arrival is 20% may be determined in the pre-charging plan 2. In addition, a case in which the required period of time to the destination is 90 minutes or more and regenerative braking is not performable may be relatively insufficient, as compared to a case in which regenerative braking is performable (e.g., charging is started later, at a point in time at which the remaining period of time until arrival is 5%, due to sufficient energy recovery potential, downhill segments, or frequent deceleration zones, etc.). Thus, the detailed pre-charging plan in which charging is started at a point in time at which the remaining period of time until arrival is 20% may be determined.

The pre-charging plan 2 illustrated in FIG. 8 is only one example for description and understanding, and thus the present disclosure is not limited thereto (e.g., alternate logic may use SOC slope analysis, route gradient, or forecasted energy consumption trends, etc.).

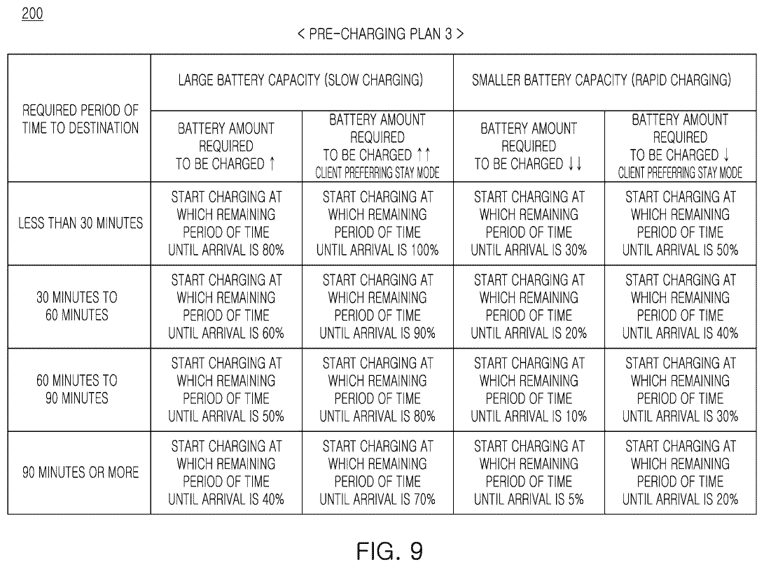

FIG. 9 shows an example of a pre-charging plan 3 of an infotainment device.

Referring to FIG. 9, the infotainment device 200 may determine a current state of the vehicle, according to a capacity of the battery of the vehicle (e.g., if the capacity is greater than or equal to a reference capacity such as 50 kWh, or is less than the reference capacity such as 30 kWh, etc.) and a remaining period of time (e.g., a time section in which a remaining period of time until arrival at a destination is subdivided into intervals such as 0-30%, 30-70%, or 70-100%, etc.), based on the server analysis information SAI and the vehicle general information VGI (e.g., vehicle travel information, fuel level information, battery degradation data, or historical usage patterns, etc.), and may determine a pre-charging plan 3 (e.g., charging is started at a point in time at which the remaining period of time until arrival is 80%, 50%, or 30%, etc.), according to a determination result. In FIG. 9, one upward arrow may mean that a battery amount required to be charged is greater than a first upper limit reference amount, two upward arrows may mean that the battery amount required to be charged is greater than a second upper limit reference amount (e.g., higher than the first upper limit reference amount by a predefined threshold, etc.), one downward arrow may mean that the battery amount required to be charged is less than a first lower limit reference amount, and two downward arrows may mean that the battery amount required to be charged is less than a second lower limit reference amount (e.g., lower than the first lower limit reference amount by a predefined threshold, etc.).

Referring to the pre-charging plan 3 illustrated in FIG. 9, whether the battery capacity is greater or less than a reference capacity may be determined (e.g., based on thresholds such as 60 kWh for high-capacity batteries or 30 kWh for compact vehicle batteries, etc.). In addition, if the battery capacity is greater than the reference capacity, whether the battery amount required to be charged is greater than the first upper limit reference amount or is greater than the second upper limit reference amount may be determined (e.g., where the first upper limit may represent moderate charging demand and the second upper limit may represent a critical or high-demand charging threshold, etc.). If the battery capacity is less than the reference capacity, whether the battery amount required to be charged is less than the first lower limit reference amount or is less than the second lower limit reference amount may be determined (e.g., indicating minimal charging needs for shorter stay durations or reduced system use, etc.). In addition, whether a client is a client preferring a stay mode may be determined (e.g., based on historical stay mode usage frequency, duration of past sessions, selection of comfort features such as HVAC or media during idle time, or manual preference settings, etc.). With respect to above-described cases, the pre-charging plan 3 may be determined according to the required period of time (or the remaining period of time) to the destination (e.g., using thresholds such as less than 30 minutes, 30-60 minutes, or 90 minutes or more, etc.).

For example, if the battery capacity is greater than the reference capacity (e.g., in long-range electric vehicles or vehicles equipped with extended battery packs, etc.), the battery amount required to be charged is greater than the first upper limit reference amount (e.g., exceeding 30% of total capacity or triggered by high power accessory usage, etc.), the client is not the client preferring the stay mode (e.g., based on lack of prior usage, low dwell times, or default settings, etc.), and the required period of time (or the remaining period of time) to the destination is less than 30 minutes (e.g., in short trips within city limits or last-mile travel, etc.), a detailed pre-charging plan in which charging is started at a point in time at which the remaining period of time until arrival is 80% may be determined in the pre-charging plan 3. In addition, a case in which the required period of time to the destination is less than 30 minutes, the battery capacity is greater than the reference capacity, and the battery amount required to be charged is greater than a current battery amount of the vehicle may be relatively insufficient, as compared to a case in which the battery capacity is less than the reference capacity and the battery amount required to be charged is less than a reference battery amount (e.g., charging is started at a point in time at which the remaining period of time is 50%, such as for smaller-capacity EVs or low-consumption stay mode sessions, etc.). Thus, the detailed pre-charging plan in which charging is started at a point in time at which the remaining period of time until arrival is 80% may be determined.

For another example, if the battery capacity is less than the reference capacity (e.g., in compact electric vehicles, plug-in hybrids, or aging battery systems, etc.), the battery amount required to be charged is less than the first lower limit reference amount (e.g., below 15% of total capacity or minimal expected energy use during stay mode, etc.), the client is the client preferring the stay mode e.g., based on frequent usage history, extended idle durations, or user-configured preferences, etc.), and the required period of time (or the remaining period of time) to the destination is 90 minutes or more (e.g., during intercity travel, road trips, or extended highway driving, etc.), a detailed pre-charging plan in which charging is started at a point in time at which the remaining period of time until arrival is 20% may be determined in the pre-charging plan 3. In addition, a case in which the required period of time to the destination is 90 minutes or more, the battery capacity is less than the reference capacity, and the battery amount required to be charged is less than the current battery amount of the vehicle may be relatively sufficient, as compared to a case in which the battery capacity is greater than the reference capacity and the battery amount required to be charged is greater than the first upper limit reference amount (e.g., charging is actively started at a point in time at which the remaining period of time until arrival is 40%,, such as in high-consumption scenarios or for long stay durations, etc.). Thus, the detailed pre-charging plan in which charging is started at a point in time at which the remaining period of time until arrival is 20% may be determined.

The pre-charging plan 3 illustrated in FIG. 9 is only one example for description and understanding, and thus the present disclosure is not limited thereto (e.g., alternate plans may take into account ambient temperature, route elevation, regenerative braking availability, or traffic conditions, etc.).

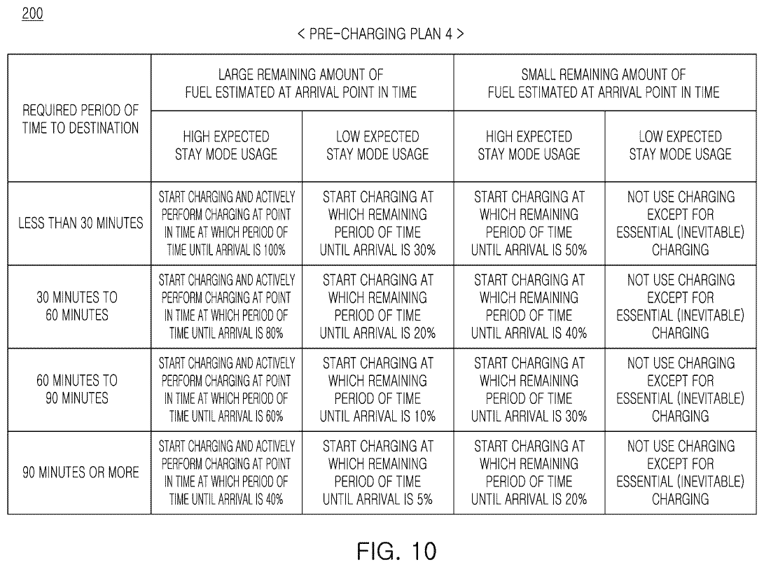

FIG. 10 shows an example of a pre-charging plan 4 of an infotainment device.

Referring to FIG. 10, the infotainment device 200 may determine a current state of the vehicle according to a remaining amount of fuel estimated at an arrival point (e.g., if the remaining amount of fuel is greater than or equal to a reference amount such as 30%, or is less than a reference amount such as 10%, etc.) and a remaining period of time (e.g., a time section in which a remaining period of time until arrival at a destination is subdivided into segments such as 0 -30 minutes, 30-60 minutes, or over 90 minutes, etc.), based on the server analysis information SAI and the vehicle general information VGI (e.g., vehicle travel information, fuel level information, route distance information, or historical fuel consumption data, etc.), and may determine a pre-charging plan 4 (e.g., charging is actively started at a point in time at which the remaining period of time until arrival is 100%, 70%, or 50%, etc.), according to a determination result.

Referring to the pre-charging plan 4 illustrated in FIG. 10, whether the remaining amount of fuel estimated at an arrival point in time is greater or less than the reference amount may be determined. In addition, whether expected stay mode usage is high or low may be determined (e.g., based on destination type, historical usage patterns, or driver preference settings, etc.). With respect to above-described cases, the pre-charging plan 4 may be determined according to the required period of time (or the remaining period of time) to the destination.

For example, if the amount of remaining fuel estimated at the arrival point in time is greater than the reference amount (e.g., more than 50% of the fuel tank capacity, or sufficient for auxiliary systems operation during stay mode, etc.), the expected stay mode usage is high (e.g., based on past behavior such as frequent activation, long idle durations, or destination type like campsites or sports events, etc.), and the required period of time (or the remaining period of time) to the destination is less than 30 minutes (e.g., short-distance city driving or neighborhood travel, etc.), a detailed pre-charging plan in which charging is started and actively performed at a point in time at which the remaining period of time until arrival is 100% may be determined in the pre-charging plan 4. In addition, a case in which the required period of time to the destination is less than 30 minutes, the remaining amount of fuel estimated at the arrival point in time is greater than the reference amount, and the expected stay mode usage is high may have relatively high stay mode usability, as compared to a case in which the expected stay mode usage is low (e.g., charging is started at a point in time at which the remaining period of time until arrival is 30%, such as in short breaks or brief errands, etc.). Thus, the detailed pre-charging plan in which charging is more actively performed at a point in time at which the remaining period of time until arrival is 100% (e.g., at the same time as departure) may be determined.

For another example, if the remaining amount of fuel estimated at the arrival point in time is less than the reference amount (e.g., below 15% of tank capacity, or insufficient to support idle energy demands, etc.), the expected stay mode usage is low (e.g., based on minimal historical activation, short anticipated idle time, or destination type such as gas stations or drop-off zones, etc.), and the required period of time (or the remaining period of time) to the destination is 90 minutes or more (e.g., indicating a long-distance drive on highways or rural roads, etc.), a detailed pre-charging plan in which charging is not used except for essential (inevitable) charging may be determined in the pre-charging plan 4. In addition, a case in which the required period of time to the destination is 90 minutes or more, the remaining amount of fuel estimated at the arrival point in time is less than the reference amount, and the expected stay mode usage is low may have relatively low stay mode usability, as compared to a case in which the expected stay mode usage is high (e.g., charging is started at a point in time at which the remaining period of time until arrival is 20%, such as for long idling at events, campsites, or rest areas, etc.). Thus, the pre-charging plan may not be used except for a case in which charging is inevitably required (e.g., to prevent shutdown of auxiliary systems or HVAC due to battery depletion, etc.).

If an excessively small amount of fuel is expected at the arrival point in time, a gas station may be guided on the navigation screen to induce fuel refilling, and charging for a stay mode may not be performed (e.g., stay mode is suppressed to conserve energy or prevent fuel exhaustion, emergency standby needs, or passenger comfort concerns, etc.).

The pre-charging plan 4 illustrated in FIG. 10 is only one example for description and understanding, and thus the present disclosure is not limited thereto (e.g., alternative logic may involve terrain analysis, weather-based energy forecasts, or vehicle occupancy levels, etc.).

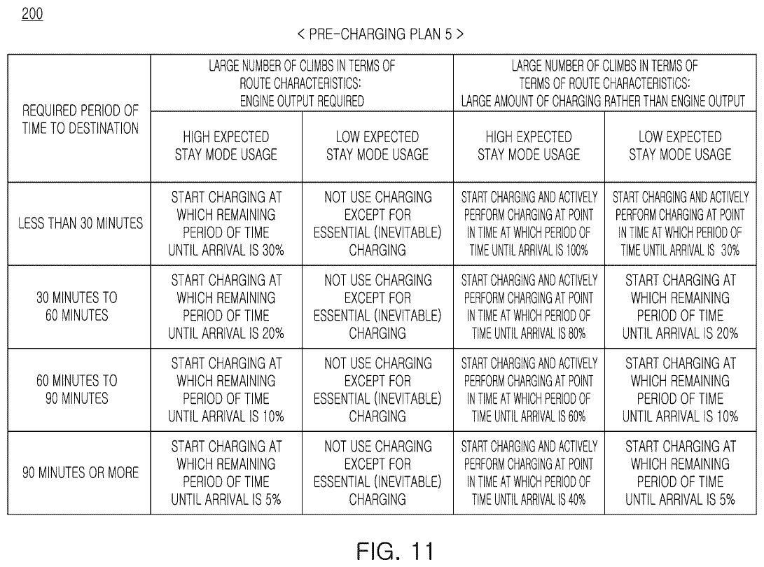

FIG. 11 shows an example of a pre-charging plan 5 of an infotainment device.

Referring to FIG. 11, the infotainment device 200 may determine a current state of the vehicle according to route characteristics to a destination (e.g., when the route includes a large number of climbs, descents, sharp curves, or stop-and-go segments, etc.) and a remaining period of time (e.g., a time section in which a remaining period of time until arrival at the destination is subdivided into intervals such as 0-30%, 30-70%, or 70-100%, etc.), based on the server analysis information SAI and the vehicle general information VGI (e.g., vehicle travel information, fuel consumption rate, terrain data, or route elevation profile, etc.), and may determine a pre-charging plan 5 (e.g., charging is started at a point in time at which the remaining period of time until arrival is 30%, 50%, or 70%, etc.), according to a determination result.

Referring to the pre-charging plan 5 illustrated in FIG. 11, a case in which there are a large number of climbs (engine output is required) and a case in which there are a large number of descents (a large amount of charging is required rather than engine output) may be determined in terms of route characteristics. With respect to each of the cases, whether expected stay mode usage is high or low may be determined (e.g., based on destination type, previous usage history, or typical duration of stop, etc.). With respect to above-described cases, the pre-charging plan 5 may be determined according to the required period of time (or the remaining period of time) to the destination (e.g., categorized as short, medium, or long trips, etc.).

For example, if there are a large number of climbs in terms of route characteristics (e.g., steep inclines, hilly terrain, or mountainous roads requiring sustained engine output, etc.), the expected stay mode usage is high (e.g., when the destination is a campsite, outdoor event, or known rest location with extended idling, etc.), and the required period of time (or the remaining period of time) to the destination is less than 30 minutes (e.g., approaching the final leg of a trip or nearing a short-range destination, etc.), a detailed pre-charging plan in which charging is started at a point in time at which the remaining period of time until arrival is 30% may be determined in the pre-charging plan 5. In addition, a case in which the required period of time to the destination is less than 30 minutes, there are a large number of climbs in terms of route characteristics, and the expected stay mode usage is high may be relatively insufficient, as compared to a case in which the expected stay mode usage is low (e.g., pre-charging is not used except for inevitable charging or emergency system activation, such as HVAC support in hot weather or battery health maintenance, etc.). Thus, the detailed pre-charging plan in which charging is started at a point in time at which the remaining period of time until arrival is 30% may be determined.

For another example, if there are a large number of descents in terms of route characteristics (e.g., downhill segments, sloped expressways, or mountainous declines allowing regenerative braking, etc.), the expected stay mode usage is low (e.g., for quick stops, low idling durations, or destinations such as parking lots or fuel stations, etc.), and the required period of time (or the remaining period of time) to the destination is 90 minutes or more (e.g., during prolonged highway travel or intercity commutes, etc.), a detailed pre-charging plan in which charging is started at a point in time at which the remaining period of time until arrival is 5% may be determined in the pre-charging plan 5. In addition, a case in which the required period of time to the destination is 90 minutes or more, there are a large number of descents in terms of route characteristics, and the expected stay mode usage is low may be relatively sufficient, as compared to a case in which the expected stay mode usage is high (e.g., charging is actively started at a point in time at which the remaining period of time until arrival is 40%, such as when approaching an event site, recreational area, or long-term idle location, etc.). Thus, the detailed pre-charging plan in which charging is started at a point in time at which the remaining period of time until arrival is 5% may be determined.

The pre-charging plan 5 illustrated in FIG. 11 is only one example for description and understanding, and thus the present disclosure is not limited thereto (e.g., variations may consider real-time weather, traffic congestion, or regenerative braking capability along the route, etc.).

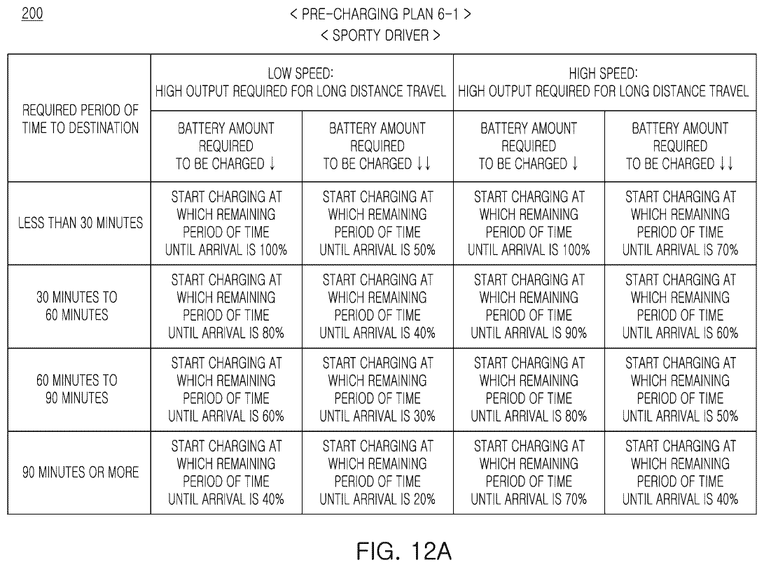

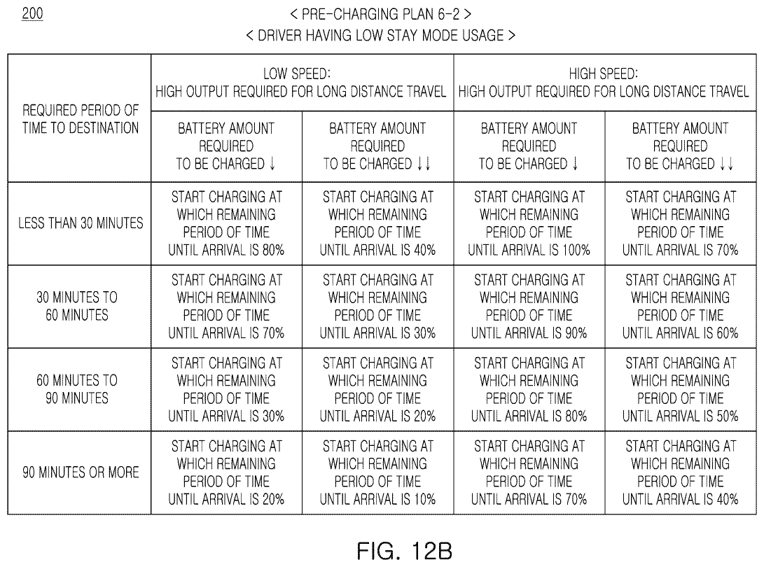

FIG. 12A shows an example of a pre-charging plan 6-1 of the infotainment device, and FIG. 12B shows an example of a pre-charging plan 6-2 of an infotainment device.

Referring to FIGS. 12A and 12B, the infotainment device 200 may determine a current state of the vehicle according to a driving habit (e.g., a driving style such as aggressive or conservative, and a stay mode preference such as frequent use or rare use, etc.) of a driver and a remaining period of time (e.g., a time section in which a remaining period of time until arrival at a destination is subdivided into intervals such as 0-30%, 30-70%, or 70-100%, etc.), based on the server analysis information SAI and the vehicle general information VGI (e.g., vehicle travel information, recent fuel consumption patterns, SOC history, or typical stop durations, etc.), and may determine pre-charging plans 6-1 and 6-2 (e.g., charging is started at a point in time at which the remaining period of time until arrival is 30%, 50%, 70%, or 100%, etc.), according to a determination result.

Referring to the pre-charging plan 6-1 illustrated in FIG. 12A and the pre-charging plan 6-2 illustrated in FIG. 12B, whether the driver is a sporty driver (the pre-charging plan 6-1) or a driver having low stay mode usage (the pre-charging plan 6-2) may be determined (e.g., based on acceleration patterns, frequency of stay mode activation, or user profile settings, etc.). With respect to each of a case in which the driver is a sport driver and a case in which the driver is a driver having low stay mode usage, whether a travel speed is a high speed, higher than or equal to a reference speed, or is a low speed, lower than the reference speed may be determined (e.g., reference speed thresholds such as 80 km/h for highway vs. 30 km/h for city driving, etc.). With respect to each of the above-described cases, whether a battery amount required to be charged is less than or equal to a first lower limit reference amount or is less than or equal to a second lower limit reference amount may be determined (e.g., thresholds such as 20% or 10% of total battery capacity,, or based on energy needs for HVAC and entertainment systems during stay mode, etc.). With respect to each of the above-described cases, the pre-charging plan 6-1 and the pre-charging plan 6-2 may be determined according to the required period of time (or the remaining period of time) to the destination (e.g., short trips under 30 minutes, medium trips around 60 minutes, or long trips over 90 minutes, etc.).

For example, if the driver habit is a sporty driver (the pre-charging plan 6-1 is determined), the travel speed is a low speed (e.g., in stop-and-go traffic, residential areas, or during frequent braking, etc.), the battery amount required to be charged is less than the first lower limit reference amount (e.g., less than 20% of total capacity, or based on minimal predicted idle load, etc.), the required period of time (or the remaining period of time) to the destination is less than 30 minutes (e.g., for short-range city driving or approaching a known stay mode destination, etc.), a detailed pre-charging plan in which charging is started at a point in time at which the remaining period of time until arrival is 100% (that is, at the same time as departure) may be determined in the pre-charging plan 6-1. In addition, a case in which the driver habit is a sporty driver (the pre-charging plan 6-1 is determined), the required period of time to the destination is less than 30 minutes, the travel speed is a low speed and the battery amount required to be charged is less than the first lower limit reference amount may be relatively insufficient, as compared to a case (e.g., charging is started at a point in time at which the remaining period of time until arrival is 50%, such as in moderate consumption scenarios, etc.) in which the battery amount required to be charged is less than the second lower limit reference amount (e.g., a reference amount lower than the first lower limit reference amount, such as below 10%, etc.). Thus, the detailed pre-charging plan in which charging is started at a point in time at which the remaining period of time until arrival is 100% (that is, at the same time as departure) may be determined.

For another example, if the driver habit is a driver having low stay mode usage (the pre-charging plan 6-2 is determined), the travel speed is a high speed (e.g., sustained highway driving, express lanes, or minimal stop conditions, etc.), the battery amount required to be charged is less than the second lower limit reference amount (e.g., below 10% of battery capacity or only minimal auxiliary load expected, etc.), and the required period of time (or the remaining period of time) to the destination is 90 minutes or more (e.g., during long-distance travel or road trips, etc.), a detailed pre-charging plan in which charging is started at a point in time at which the remaining period of time until arrival is 40% may be determined in the pre-charging plan 6-2. In addition, a case in which the driver habit is a driver having low stay mode usage (the pre-charging plan 6-2 is determined), the required period of time to the destination is 90 minutes or more, the travel speed is a high speed, and the battery amount required to be charged is less than the second lower limit reference amount may be relatively sufficient, as compared to a case in which the battery amount required to be charged is less than the first lower limit reference amount (e.g., a reference amount, greater than the second lower limit reference amount, e.g., between 10% and 20%, indicating a higher but still limited energy need, etc.). Thus, the detailed pre-charging plan in which charging is started at a point in time at which the remaining period of time until arrival is 40% may be determined.

The pre-charging plan 6-1 illustrated in FIG. 12A and the pre-charging plan 6-2 illustrated in FIG. 12B are only examples for description and understanding, and thus the present disclosure is not limited thereto (e.g., other plans may be created for eco-driving habits, frequent idling users, or shared vehicles with mixed profiles, etc.).

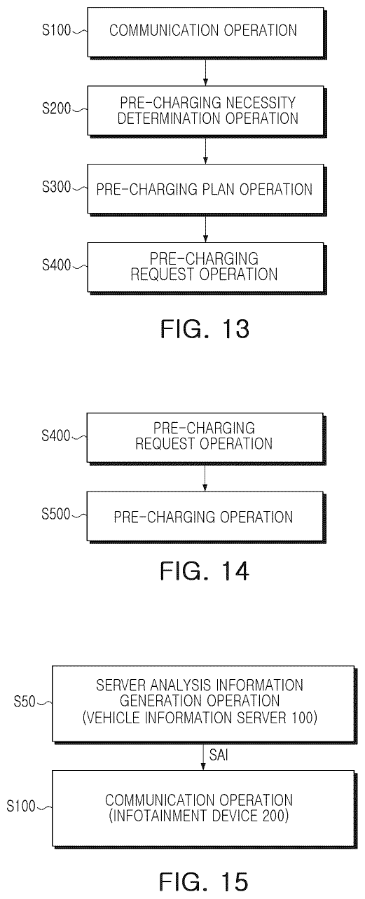

Hereinafter, a vehicle battery pre-charging method for a stay mode will be described with reference to FIGS. 13 to 19. In the present application, the description of the vehicle battery pre-charging method for the stay mode and the description of the vehicle battery pre-charging apparatus for the stay mode may complement each other or may be applied in common, unless the descriptions are mutually exclusive. Accordingly, a repeated description may be omitted. Hereinafter, main processes in the vehicle battery pre-charging method for the stay mode will be described.

FIG. 13 shows an example of a vehicle battery pre-charging method for a stay mode according to an example of the present disclosure.

Referring to FIGS. 1 and 13, a vehicle battery pre-charging method for a stay mode according to an example of the present disclosure may be performed, for example, by a vehicle battery pre-charging apparatus 50 for a stay mode (e.g., comprising an infotainment device, vehicle controller, and communication interface, etc.).

For example, the vehicle battery pre-charging method for the stay mode may include a communication operation S100, a pre-charging necessity determination operation S200, a pre-charging plan operation S300, and a pre-charging request operation S400 (e.g., executed sequentially or in parallel based on vehicle state, system readiness, or user inputs, etc.).

In the communication operation S100, an infotainment device 200 (see FIG. 1) of the vehicle battery pre-charging apparatus 50 (see FIG. 1) may upload vehicle general information VGI to a vehicle information server 100, and may download server analysis information SAI from the vehicle information server 100 (e.g., using a mobile network, Wi-Fi, satellite link, or telematics gateway, etc.).

In the pre-charging necessity determination operation S200, the infotainment device 200 (see FIG. 1) of the vehicle battery pre-charging apparatus 50 (see FIG. 1) may determine pre-charging necessity according to a possibility of using the stay mode, based on the server analysis information SAI and the vehicle general information VGI (e.g., destination type, idle behavior, driving history, or user preferences, etc.).

In the pre-charging plan operation S300, if there is the possibility of using the stay mode, the infotainment device 200 (see FIG. 1) of the vehicle battery pre-charging apparatus 50 (see FIG. 1) may determine a stay mode pre-charging plan according to a current state of a vehicle, based on the server analysis information SAI and the vehicle general information VGI (e.g., remaining SOC, trip distance, fuel level, or regenerative braking availability, etc.).

In addition, in the pre-charging request operation S400, the infotainment device 200 of the vehicle battery pre-charging apparatus 50 (see FIG. 1) may request pre-charging according to the stay mode pre-charging plan from a vehicle controller 300, which will be described with reference to FIG. 14.

FIG. 14 shows an example of a pre-charging operation in response to a stay mode request.

Referring to FIG. 14, the vehicle battery pre-charging method may further include a pre-charging operation S500.

For example, in the pre-charging operation S500, the vehicle controller 300 (see FIG. 1) of the vehicle battery pre-charging apparatus 50 (see FIG. 1) may control pre-charging for a battery of the vehicle according to the pre-charging plan received from the infotainment device 200 in response to a request from the infotainment device 200 (e.g., by adjusting generator load, engine RPM, or power allocation, etc.).

For example, the vehicle controller 300 may use a battery management system (BMS) to pre-charge a battery mounted in a vehicle 10 (see FIG. 1) (e.g., a lithium-ion battery, solid-state battery, or hybrid energy storage system, etc.).

FIG. 15 shows an example of a server analysis information generation operation.

Referring to FIG. 15, the vehicle battery pre-charging method may further include a server analysis information generation operation S50.

For example, in the server analysis information generation operation S50, with respect to each vehicle, the vehicle information server 100 (see FIG. 1) of the vehicle battery pre-charging apparatus (see FIG. 1) may (i) analyze the possibility of using the stay mode, ii) analyze a driving habit, and (iii) analyze a required period of time and energy characteristics according to a route during travel, based on the vehicle general information VGI, to generate server analysis information SAI for each vehicle, before the communication operation S100 (e.g., by using machine learning, statistical modeling, or pattern recognition algorithms to detect patterns such as frequent idle behavior, repeated destination types, speed variations, SOC depletion trends, or terrain-dependent energy usage, etc.).

wherein the server analysis information SAI includes at least one of: analysis information on a possibility of using the stay mode, analysis information on a driving habit of a driver of the vehicle, and analysis information on a required period of time to a destination and energy characteristics associated with a travel route, based on the vehicle information, wherein the vehicle information comprises vehicle driving information, a profile of the driver, vehicle travel, and vehicle fuel information.

For example, the vehicle general information VGI may include vehicle driving information, a driver profile, navigation information (including vehicle travel information), and vehicle fuel information (e.g., fuel level trends, estimated fuel efficiency, or number of recent refuels, etc.).

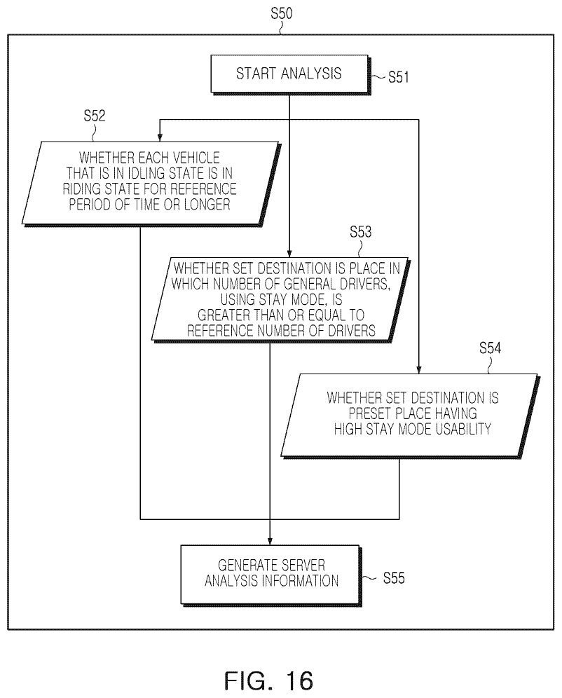

FIG. 16 shows an example of a detailed operation of an operation of generating server analysis information.

Referring to FIG. 16, for example, in the server analysis information generation operation S50), the vehicle information server 100 (see FIG. 1) of the vehicle battery pre-charging apparatus 50 (see FIG. 1) may start analysis based on the vehicle general information VGI (S51), with respect to each vehicle, (i) whether each vehicle that is in an idling state remains in a riding state for a reference period of time or longer (S52), (ii) whether a set destination is a place in which the number of general drivers, using the stay mode, is greater than or equal to a reference number of drivers (S53), and/or (iii) whether the set destination is a preset place having high stay mode usability (S54), and may generate the server analysis information SAI including an analysis result (S55) (e.g., a stay mode likelihood score, a battery demand estimate, or a prioritized charging instruction, etc.).

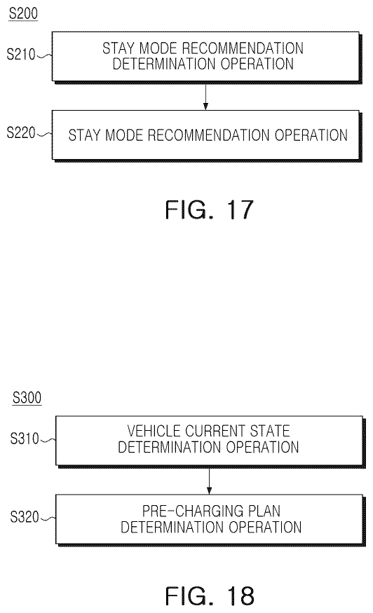

FIG. 17 shows an example of a detailed operation of a pre-charging necessity determination operation.

Referring to FIG. 17, the pre-charging necessity determination operation S200 may include a stay mode recommendation determination operation S210 and a stay mode recommendation operation S220.

For example, in the stay mode recommendation determination operation S210, the infotainment device 200 (see FIG. 1) of the vehicle battery pre-charging apparatus 50 (see FIG. 1) may determine stay mode recommendation necessity according to the possibility of using the stay mode, including whether each vehicle that is in the idling state is in the riding state for the reference period of time or longer (e.g., exceeding 10 minutes of idle with occupants present, etc.), whether the set destination is a place in which the number of general drivers, using the stay mode, is greater than or equal to a reference number of drivers (e.g., more than five vehicles per day historically using stay mode, etc.), and/or (iii) whether the set destination is the preset place having high stay mode usability, based on the server analysis information SAI (e.g., destinations such as schools, camping sites, stadiums, or event venues, where prolonged vehicle idling is common, etc.).

In the stay mode recommendation operation S220, the infotainment device 200 (see FIG. 1) may display a pop-up window 201 for stay mode recommendation on a screen, if there is a determination of stay mode recommendation necessity (e.g., “Do you want to enable Stay Mode?”).

FIG. 18 is an exemplary diagram of a detailed operation of a pre-charging plan operation.

Referring to FIG. 18, the pre-charging plan operation S300 may include a vehicle current state determination operation S310 and a pre-charging plan determination operation S320.

For example, in the vehicle current state determination operation S310, if there is a possibility of using the stay mode, the infotainment device 200 (see FIG. 1) of the vehicle battery pre-charging apparatus 50 (see FIG. 1) may determine a current state of the vehicle, based on the server analysis information SAI and the vehicle general information VGI (e.g., vehicle travel distance, speed history, idle time, and fuel efficiency data, etc.).

In the pre-charging plan determination operation S320, the infotainment device 200 (see FIG. 1) of the vehicle battery pre-charging apparatus 50 (see FIG. 1) may determine a pre-charging plan (e.g., charging is started at a point in time at which a remaining period of time until arrival is 100%, 70%, 50%, or 40%, etc.) in relation to a charging start point in time and a charging method, according to a determination result (e.g., use of engine power, regenerative braking timing, or targeted SOC level, etc.).

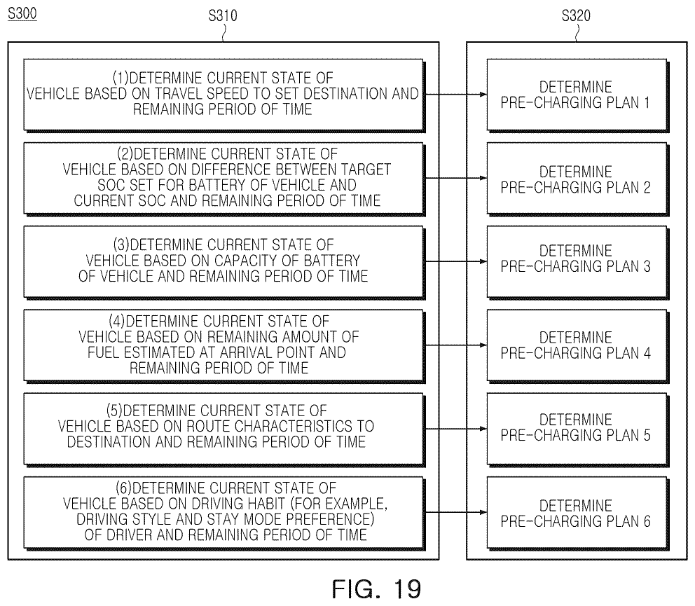

FIG. 19 shows an example of a detailed operation of a pre-charging plan determination operation.

Referring to FIG. 19, for example, in the pre-charging plan operation S300, the infotainment device 200 (see FIG. 1) may determine, based on the server analysis information SAI and the vehicle general information VGI (e.g., vehicle travel information, fuel level information, driver profile, or route gradient, etc.), a current state of the vehicle according to one of (i) a travel speed to a set destination and a remaining period of time, (ii) a difference between a target SOC set for a battery of the vehicle and a current SOC and a remaining period of time, (iii) a capacity of the battery of the vehicle and a remaining period of time, (iv) a remaining amount of fuel estimated at an arrival point and a remaining period of time, (v) route characteristics to a destination and a remaining period of time, and (vi) a driving habit (e.g., a driving style such as high acceleration or frequent stops, and a stay mode preference such as frequent vs. rare usage, etc.) of a driver and a remaining period of time to determine a charging plan for each case. In relation thereto, the descriptions using FIGS. 7 to 12 may be referred to.

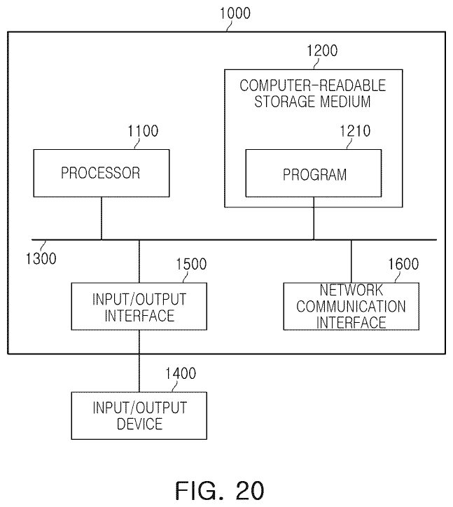

FIG. 20 shows an example of a computing device 1000 capable of entirely or partially implementing a vehicle battery pre-charging apparatus and method for a stay mode according to an example of the present disclosure.

As illustrated in FIG. 20, a computing device 1000 may include at least one processor 1100, a computer-readable storage medium 1200, and a communication bus 1300 (e.g., a system-on-chip architecture, embedded processing board, or cloud-based virtual instance, etc.).

The processor 1100 may cause the computing device 1000 to operate according to the examples described above. For example, the processor 1100 may execute one or more programs stored in the computer-readable storage medium 1200. The one or more programs may include one or more computer-executable instructions. When executed by the processor 1100, the one or more computer-executable instructions may be configured to cause the computing device 1000 to perform operations according to examples (e.g., data analysis, pattern recognition, control signal generation, or real-time optimization tasks, etc.).

The computer-readable storage medium 1200 may be configured to store the computer-executable instruction or program code, program data, and/or other suitable forms of information. A program 1210, stored in the computer-readable storage medium 1200, may include a set of instructions executable by the processor 1100. In an example, the computer-readable storage medium 1200 may be a memory (e.g., volatile memory such as a random access memory (RAM), non-volatile memory such as read-only memory (ROM), flash storage, or any suitable combination thereof), one or more magnetic disk storage devices, optical disk storage devices, flash memory devices, other types of storage media that are accessible by the computing device 1000 and are capable of storing desired information, or any suitable combination thereof.

The communication bus 1300 may interconnect various other components of the computing device 1000, including the processor 1100 and the computer-readable storage medium 1200 (e.g., using standard buses such as PCIe, I2C, SPI, or CAN, etc.).

The computing device 1000 may also include one or more input/output interfaces 1500 providing an interface for one or more input/output devices 1400, and one or more network communication interfaces 1600. The input/output interface 1500 and the network communication interface 1600 may be connected to the communication bus 1300. The network may be one of a cellular network, such as global system for mobile communications (GSM), enhanced data rates for GSM evolution (EDGE), general packet radio service (GPRS), code division multiple access (CDMA), time division-CDMA (TD-CDMA), universal mobile telecommunications system (UMTS), or long-term evolution (LTE), or another cellular network (e.g., 5G NR, Wi-Fi, or vehicle-to-cloud (V2C) communication systems, etc.).

The input/output device 1400 may be connected to other components of the computing device 1000 through the input/output interface 1500. The exemplary input/output device 1400 may include a pointing device (e.g., a mouse, trackpad, or joystick, etc.), a keyboard, a touch input device (e.g., a touchpad or touchscreen, etc.), a voice or sound input device, input devices such as various types of sensor devices (e.g., GPS modules, gyroscopes, accelerometers, ambient light sensors) and/or photographing devices (e.g., cameras or infrared sensors, etc.), and/or output devices such as a display device, a printer, a speaker, and/or a network card. The exemplary input/output device 1400 may be included in the computing device 1000 as a component included in the computing device 1000, or may be connected to the computing device 1000 as a device distinct from the computing device 1000 (e.g., via USB, Bluetooth, or wireless peripheral connection, etc.).

According to an example of the present disclosure, there is provided a vehicle battery pre-charging apparatus for a stay mode, the vehicle battery pre-charging apparatus including an infotainment device configured to upload vehicle general information on a vehicle to a vehicle information server, download server analysis information from the vehicle information server, determine a pre-charging plan for the stay mode according to a current state of the vehicle if there is a possibility of using the stay mode, based on the server analysis information and the vehicle general information, and request pre-charging according to the pre-charging plan, and a vehicle controller configured to control pre-charging for a battery of the vehicle according to the pre-charging plan received from the infotainment device, according to a request from the infotainment device.

The vehicle battery pre-charging apparatus may further include a vehicle information server configured to, with respect to each vehicle, i) analyze the possibility of using the stay mode, ii) analyze a driving habit, and (iii) analyze a required period of time and energy characteristics according to a route during travel, based on the vehicle general information including vehicle driving information, a driver profile, navigation information (including vehicle travel information), and vehicle fuel information, to transmit server analysis information to each vehicle.

The vehicle information server may include a server memory configured to store the vehicle general information, an information analysis processor configured to analyze the possibility of using the stay mode for each vehicle, based on the vehicle general information, and generate the server analysis information including an analysis result, and a first communication unit configured to receive the vehicle general information, and transmit the server analysis information.

The information analysis processor may include an information analysis unit configured to analyze, with respect to each vehicle, based on the vehicle general information, (i) whether each vehicle that is in an idling state is in a riding state for a reference period of time or longer, (ii) whether a set destination is a place in which the number of general drivers, using the stay mode, is greater than or equal to a reference number of drivers, and (iii) whether the set destination is a preset place having high stay mode usability, and a server analysis information generation unit configured to generate the server analysis information including an analysis result.

The infotainment device may be configured to display a pop-up window for stay mode operation recommendation on a screen if each vehicle that is in the idling state is in the riding state for the reference period of time or longer, if the set destination is the place in which the number of general drivers, using the stay mode, is greater than or equal to the reference number of drivers, and (iii) if the set destination is the preset place having high stay mode usability, based on the server analysis information.

The infotainment device may include a second communication unit configured to upload the to the vehicle information server, and download the server analysis information from the vehicle information server, a vehicle information processing unit configured to acquire the vehicle general information including vehicle driving information, a driver profile, and navigation information to transmit the vehicle general information to the communication unit, a navigation device configured to provide the navigation information including vehicle travel information to the vehicle information processing unit, a stay mode processing unit configured to perform entry into and exit from the stay mode, determine, before performing the stay mode, a pre-charging plan for the stay mode according to a current state of the vehicle if there is the possibility of using the stay mode, based on the server analysis information and the vehicle general information, and request pre-charging using the pre-charging plan, and an infotainment controller configured to communicate with the vehicle controller to receive the vehicle general information and transmit the vehicle general information to the vehicle information processing unit, and transmit a pre-charging request of the stay mode processing unit to the vehicle controller.

The stay mode processing unit may include a pre-charging necessity determination unit configured to determine pre-charging necessity according to the possibility of using the stay mode, based on the server analysis information and the vehicle general information, a pre-charging plan determination unit configured to determine a current state of the vehicle, based on the server analysis information and the vehicle general information, if there is the pre-charging necessity, and determine a pre-charging plan (for example, charging is started at a point in time at which a remaining period of time until arrival is 100%) in relation to a charging start point in time and a charging method, according to a determination result, and a pre-charging request unit configured to request pre-charging according to the pre-charging plan from the infotainment controller.

The infotainment device may be configured to determine the current state of the vehicle according to a travel speed to a set destination (for example, a high speed if the travel speed is equal to or higher than a reference speed or a low speed if the travel speed is lower than the reference speed) and a remaining period of time (for example, a time section in which a remaining period of time until arrival at the destination is subdivided), based on the server analysis information and the vehicle general information, and determine a pre-charging plan 1 (for example, charging is started at a point in time at which the remaining period of time until arrival is 100%), according to a determination result.

The infotainment device may be configured to determine the current state of the vehicle, according to a difference between a target state of charge (SOC) set for the battery of the vehicle and a current SOC (for example, if the difference has a value greater than or equal to a reference value, or has a value less than the reference value) and a remaining period of time (for example, a time section in which a remaining period of time until arrival at a destination is subdivided), based on the server analysis information and the vehicle general information, and determine a pre-charging plan 2 (for example, charging is started at a point in time at which the remaining period of time until arrival is 80%), according to a determination result.

The infotainment device may be configured to determine the current state of the vehicle, according to a capacity of the battery of the vehicle (for example, if the capacity is greater than or equal to a reference capacity, or is less than the reference capacity) and a remaining period of time (for example, a time section in which a remaining period of time until arrival at a destination is subdivided), based on the server analysis information and the vehicle general information, and determine a pre-charging plan 3 (for example, charging is started at a point in time at which the remaining period of time until arrival is 80%), according to a determination result.

The infotainment device may be configured to determine the current state of the vehicle according to a remaining amount of fuel estimated at an arrival point (for example, if the remaining amount of fuel is greater than or equal to a reference amount, or is less than the reference amount) and a remaining period of time (for example, a time section in which a remaining period of time until arrival at a destination is subdivided), based on the server analysis information and the vehicle general information, and determine a pre-charging plan 4 (for example, charging is actively started at a point in time at which the remaining period of time until arrival is 100%), according to a determination result.

The infotainment device may be configured to determine the current state of the vehicle according to route characteristics to a destination (for example, if there are a large number of climbs or descents) and a remaining period of time (for example, a time section in which a remaining period of time until arrival at the destination is subdivided), based on the server analysis information and the vehicle general information, and determine a pre-charging plan 5 (for example, charging is started at a point in time at which the remaining period of time until arrival is 30%), according to a determination result.

The infotainment device may be configured to determine the current state of the vehicle according to a driving habit (for example, a driving style and a stay mode preference) of a driver and a remaining period of time (for example, a time section in which a remaining period of time until arrival at a destination is subdivided), based on the server analysis information and the vehicle general information, and determine pre-charging plans 6-1 and 6-2 (for example, charging is started at a point in time at which the remaining period of time until arrival is 30%), according to a determination result.

According to another example of the present disclosure, there is provided a vehicle battery pre-charging method for a stay mode, the vehicle battery pre-charging method including a communication operation in which the infotainment device uploads vehicle general information on a vehicle to a vehicle information server and downloads server analysis information from the vehicle information server, a pre-charging necessity determination operation in which the infotainment device determines pre-charging necessity according to a possibility of using the stay mode, based on the server analysis information and the vehicle general information, a pre-charging plan operation in which the infotainment device determines a stay mode pre-charging plan according to a current state of the vehicle, based on the server analysis information and the vehicle general information, if there is the possibility of using the stay mode, and a pre-charging request operation in which the infotainment device requests pre-charging according to the stay mode pre-charging plan.

The vehicle battery pre-charging method may further include a pre-charging operation in which the vehicle controller controls pre-charging for a battery of the vehicle according to the pre-charging plan received from the infotainment device, according to a request from the infotainment device.

The vehicle battery pre-charging method may further include a server analysis information generation operation in which the vehicle information server, with respect to each vehicle, i) analyzes the possibility of using the stay mode, ii) analyzes a driving habit, and (iii) analyzes a required period of time and energy characteristics according to a route during travel, based on the vehicle general information including vehicle driving information, a driver profile, navigation information (including vehicle travel information), and vehicle fuel information, to transmit server analysis information to each vehicle, before the communication operation.

In the server analysis information generation operation, the vehicle information server may start analysis based on the vehicle general information to analyze, with respect to each vehicle, (i) whether each vehicle that is in an idling state is in a riding state for a reference period of time or longer, (ii) whether a set destination is a place in which the number of general drivers, using the stay mode, is greater than or equal to a reference number of drivers, and (iii) whether the set destination is a preset place having high stay mode usability, and may generate the server analysis information including an analysis result.

The pre-charging necessity determination operation may include a stay mode recommendation determination operation in which the infotainment device determines stay mode recommendation necessity according to the possibility of using the stay mode, including whether each vehicle that is in the idling state is in the riding state for the reference period of time or longer, whether the set destination is the place in which the number of general drivers, using the stay mode, is greater than or equal to the reference number of drivers, and (iii) whether the set destination is the preset place having high stay mode usability, based on the server analysis information, and a stay mode recommendation operation in which the infotainment device displays a pop-up window for stay mode recommendation on a screen, if there is the stay mode recommendation necessity.

The pre-charging plan operation may include a vehicle current state determination operation in which the infotainment device determines the current state of the vehicle, based on the server analysis information and the vehicle general information, if there is the possibility of using the stay mode, and a pre-charging plan determination operation in which the infotainment device determines a pre-charging plan (for example, charging is started at a point in time at which a remaining period of time until arrival is 100%) in relation to a charging start point in time and a charging method, according to a determination result.

In the pre-charging plan operation, the infotainment device may determine, based on the server analysis information and the vehicle general information, the current state of the vehicle according to one of (i) a travel speed to a set destination and a remaining period of time, (ii) a difference between a target SOC set for a battery of the vehicle and a current SOC and a remaining period of time, (iii) a capacity of the battery of the vehicle and a remaining period of time, (iv) a remaining amount of fuel estimated at an arrival point and a remaining period of time, (v) route characteristics to a destination and a remaining period of time, and (vi) a driving habit (for example, a driving style and a stay mode preference) of a driver and a remaining period of time to determine a charging plan for each case.

In addition, examples of the present disclosure are not limited to the above-described examples, and another example may be additionally understood in the process described below.

According to an example of the present disclosure, a possibility of using a stay mode may be determined based on server analysis information, and a pre-charging plan for a battery may be determined to secure an SOC required in the stay mode in advance, before the stay mode is used, in consideration of the server analysis information and vehicle general information (a travel speed/period of time to a destination, an SOC of the battery, a capacity of the battery, a remaining amount of fuel, route characteristics, driving habits, and a remaining period of time), thereby performing an optimal and efficient pre-charging according to the pre-charging plan.

For example, a stay mode may be smartly recommended based on destination characteristics (a camping site, a mart, a school, our recommended place, and the like), vehicle states (the number of passengers, remaining fuel, and a required battery amount), a driver preference, driving patterns (a route, a remaining period of time, a driving habit, a driving period of time, and a pattern), or the like, and a possibility of using the stay mode may be predicted to effectively determine an optimal pre-charging plan for a battery before the stay mode is activated, and to efficiently secure and manage a remaining battery amount in advance.

Example of the present disclosure may include a program for performing the methods described herein on a computer, and a computer-readable recording medium including the program. The computer-readable recording medium may include, alone or in combination with program instructions, local data files, local data structures, and the like. The medium may be those specially designed and constructed for the purposes of the examples, or may be of the well-known kind and available to those having skill in the computer software arts. Examples of the computer-readable medium include magnetic media such as hard disks, floppy disks, and magnetic tape, optical media such as CD ROM discs and DVDs, magneto-optical media such as optical discs, and hardware devices that are specially configured to store and perform program instructions, such as read-only memory (ROM), random access memory (RAM), flash memory, and the like. Examples of the program may include both a machine code, such as a code produced by a compiler, and a higher-level code that may be executed by the computer using an interpreter.

While examples have been shown and described above, it will be apparent to those skilled in the art that modifications and variations could be made without departing from the scope of the present disclosure as defined by the appended claims.

What is claimed:

1. An apparatus for a vehicle, the apparatus comprising:
a processor; and
a memory storing at least one instruction that, when executed by the processor communicating with the memory, is configured to cause the apparatus to:
send, using an infotainment device of the apparatus, vehicle information of the vehicle to a server,
receive, using the infotainment device, server analysis information of the vehicle information from the server,
determine, based on the server analysis information of the vehicle information and a current state of the vehicle, a pre-charging plan for a stay mode of the vehicle,
generate, based on the pre-charging plan, a signal requesting pre-charging a battery of the vehicle; and
control, based on the signal and the pre-charging plan, the pre-charging the battery of the vehicle.

2. The apparatus of claim 1, wherein the server analysis information comprises at least one of:
analysis information on a possibility of using the stay mode,
analysis information on a driving habit of a driver of the vehicle, wherein the stay mode corresponds to a state in which the vehicle remains stationary with at least one onboard device consuming power from the battery of the vehicle,
analysis information on a required period of time to a destination and energy characteristics associated with a travel route, based on the vehicle information,
wherein the vehicle information comprises vehicle driving information, a profile of the driver, vehicle travel information, and vehicle fuel information.

3. The apparatus of claim 1, wherein the server analysis information comprises at least one of:
(i) analysis information regarding whether the vehicle is stationary and occupied for a reference period of time or longer, (ii) analysis information regarding whether a destination is set to a place in which a number of drivers, using the stay mode, is greater than or equal to a reference number of drivers, or (iii) analysis information regarding whether the destination is a preset place having a stay mode usability.

4. The apparatus of claim 1, wherein the at least one instruction, when executed by the processor communicating with the memory, is configured to cause the apparatus to display, using the infotainment device, a pop-up window for a stay mode operation recommendation on a screen based on the server analysis information indicating at least one of:
whether the vehicle is stationary and occupied for a reference period of time or longer,
whether a destination being set to a place in which a number of drivers, using the stay mode, is greater than or equal to a reference number of drivers, or
whether the destination being a preset place having a stay mode usability level exceeding a threshold level.

5. The apparatus of claim 1, wherein the at least one instruction, when executed by the processor communicating with the memory, is configured to cause the apparatus to:
obtain the vehicle information comprising vehicle driving information, a profile of a driver of the vehicle, and navigation information, wherein the navigation information comprises vehicle travel information,
perform entry into and exit from the stay mode of the vehicle,
determine, before performing the stay mode, the pre-charging plan for the stay mode based on a possibility of using the stay mode.

6. The apparatus of claim 5, wherein the at least one instruction, when executed by the processor communicating with the memory, is configured to cause the apparatus to:
determine a pre-charging necessity based on the possibility of using the stay mode,
determine, based on the pre-charging necessity, the current state of the vehicle,
determine, based on the current state of the vehicle, the pre-charging plan, wherein the pre-charging plan comprises a charging start point in time and a charging method, and wherein the charging start point in time is determined based on a remaining period of time until arrival of the vehicle to a destination, and
request, based on the pre-charging plan, pre-charging the battery of the vehicle.

7. The apparatus of claim 6, wherein the at least one instruction, when executed by the processor communicating with the memory, is configured to cause the apparatus to:
determine the current state of the vehicle based on a travel speed to the destination and the remaining period of time, and
determine the pre-charging plan, wherein the charging start point in time corresponds to a departure time at which the vehicle begins traveling toward the destination.

8. The apparatus of claim 6, wherein the at least one instruction, when executed by the processor communicating with the memory, is configured to cause the apparatus to:
determine the current state of the vehicle based on the remaining period of time and a difference between a target state of charge (SOC) set for the battery and a current SOC of the battery, and
determine the pre-charging plan, wherein the charging start point in time is set at a point in time corresponding to a predetermined portion of the remaining period of time until arrival.

9. The apparatus of claim 6, wherein the at least one instruction, when executed by the processor communicating with the memory, is configured to cause the apparatus to:
determine the current state of the vehicle based on a capacity of the battery and the remaining period of time, and
determine the pre-charging plan, wherein the charging start point in time is set at a point in time corresponding to a predetermined portion of the remaining period of time until arrival.

10. The apparatus of claim 6, wherein the at least one instruction, when executed by the processor communicating with the memory, is configured to cause the apparatus to:
determine the current state of the vehicle based on a remaining amount of fuel estimated at an arrival point and the remaining period of time, and
determine the pre-charging plan, wherein the charging start point in time corresponds to a departure time at which the vehicle begins traveling toward the destination.

11. The apparatus of claim 6, wherein the at least one instruction, when executed by the processor communicating with the memory, is configured to cause the apparatus to:
determine the current state of the vehicle based on route characteristics to the destination and the remaining period of time, wherein the route characteristics comprise at least one of a number of climbs or a number of descents, and
determine the pre-charging plan, wherein the charging start point in time is set at a point in time corresponding to a predetermined portion of the remaining period of time until arrival.

12. The apparatus of claim 6, wherein the at least one instruction, when executed by the processor communicating with the memory, is configured to cause the apparatus to:
determine the current state of the vehicle based on a driving habit of a driver of the vehicle and the remaining period of time, wherein the driving habit comprises at least one of a driving style or a stay mode preference, and
determine the pre-charging plan, wherein the charging start point in time is set at a point in time corresponding to a predetermined portion of the remaining period of time until arrival.

13. A method performed by an apparatus for a vehicle, the method comprising:
sending vehicle information of the vehicle to a server;
receiving server analysis information of the vehicle information from the server;
determining whether to perform pre-charging a battery of the vehicle based on the server analysis information of the vehicle information;
based on a determination to perform the pre-charging, determining a pre-charging plan for a stay mode of the vehicle based on a current state of the vehicle;
generating, based on the pre-charging plan, a signal requesting pre-charging the battery of the vehicle; and
controlling, based on the signal and the pre-charging plan, the pre-charging the battery of the vehicle.

14. The method of claim 13, wherein the server analysis information comprises at least one of:
analysis information on a possibility of using the stay mode,
analysis information on a driving habit of a driver of the vehicle, and
analysis information on a required period of time to a destination and energy characteristics associated with a travel route, based on the vehicle information,
wherein the vehicle information comprises vehicle driving information, a profile of the driver, vehicle travel, and vehicle fuel information.

15. The method of claim 13, wherein the pre-charging plan for the stay mode of the vehicle is based on at least one of:
whether the vehicle is stationary and occupied for a reference period of time or longer,
whether a destination is set to a place in which a number of drivers, using the stay mode, is greater than or equal to a reference number of drivers, or
whether the destination is a preset place having a stay mode usability level exceeding a threshold level.

16. The method of claim 13, further comprising:
determining a stay mode recommendation necessity based on a possibility of using the stay mode, wherein the possibility of using the stay mode is based on at least one of:
whether the vehicle is stationary and occupied for a reference period of time or longer,
whether a destination is set to a place in which a number of drivers, using the stay mode, is greater than or equal to a reference number of drivers, or
whether the destination is a preset place having a stay mode usability level exceeding a threshold level; and
displaying, based on the determining the stay mode recommendation necessity, a pop-up window for a stay mode recommendation on a screen.

17. The method of claim 13, further comprising:
determining the current state of the vehicle based on a possibility of using the stay mode and the server analysis information of the vehicle information; and
determining, based on the current state of the vehicle, a pre-charging plan, wherein the pre-charging plan comprises a charging start point in time and a charging method, and wherein the charging start point in time corresponds to a departure time at which the vehicle begins traveling toward a destination.

18. The method of claim 17, wherein the determining the current state of the vehicle is based on at least one of:
a travel speed to the destination and a remaining period of time until arrival of the vehicle to the destination,
a difference between a target state of charge (SOC) set for the battery and a current SOC of the battery and the remaining period of time,
a capacity of the battery and the remaining period of time,
a remaining amount of fuel estimated at an arrival point and the remaining period of time,
route characteristics to the destination and the remaining period of time, or
a driving habit of a driver of the vehicle and the remaining period of time, wherein the driving habit comprises at least one of a driving style or a stay mode preference.

19. An apparatus for a vehicle, the apparatus comprising:
a processor; and
a memory storing at least one instruction that, when executed by the processor communicating with the memory, is configured to cause the apparatus to:
determine whether to recommend a stay mode of the vehicle based on analysis data of vehicle information from a server, wherein the stay mode corresponds to a state in which the vehicle remains stationary with at least one onboard device consuming power from a battery of the vehicle,
determine, based on a current state of the vehicle and a determination to recommend the stay mode, a pre-charging plan for pre-charging the battery of the vehicle, and
control, based on the pre-charging plan, pre-charging the battery before operating the vehicle in the stay mode.

20. The apparatus of claim 19, wherein whether to recommend the stay mode is based on at least one of:
whether the vehicle remains stationary with an occupant for at least a reference period of time, and
whether a destination of the vehicle corresponds to a location having a frequency of stay mode usage exceeding a reference threshold.
